(19) United States
(12) Patent Application Publication
(10) Pub. No.: US 2020/0252652 A1
(43) Pub. Date: Aug. 6, 2020

(54) ENCODING DEVICE, DECODING DEVICE, ENCODING METHOD, AND DECODING METHOD

(71) Applicant: Naoto SHIRAISHI, Kanagawa (JP)

(72) Inventor: Naoto SHIRAISHI, Kanagawa (JP)

(21) Appl. No.: 16/780,922

(22) Filed: Feb. 4, 2020

(30) Foreign Application Priority Data
Feb. 6, 2019 (JP) 2019-020041

(51) Int. Cl. H04N 19/625; H04N 19/184; H04N 19/119; H04N 19/124; H04N 19/176; H04N 19/182

(52) U.S. Cl. CPC H04N 19/625; H04N 19/184; H04N 19/182; H04N 19/124; H04N 19/176; H04N 19/119

(57) ABSTRACT

An encoding device is configured to encode an image. The encoding device includes processing circuitry configured to generate an image block obtained by dividing the image by a predetermined number of pixels; perform a frequency conversion process on the image block, to generate a frequency conversion coefficient of each pixel in the image block; generate a quantized coefficient obtained by quantizing the frequency conversion coefficient; perform a zero bit encoding process on the quantized coefficient, to generate zero bit encoded data; and generate an image code from the zero bit encoded data.

### CROSS-REFERENCE TO RELATED APPLICATION

This patent application is based on and claims priority pursuant to 35 U.S.C. § 119(a) to Japanese Patent Application No. 2019-020041, filed on Feb. 6, 2019, in the Japan Patent Office, the entire disclosure of which is hereby incorporated by reference herein.

### BACKGROUND

### Technical Field

The present invention relates to an encoding device, a decoding device, and an encoding method.

### Discussion of the Background Art

In recent years, the resolution of digital images has become higher, the size of data to be processed in image processing has become larger, and the image processing has become complicated. As a result, a large amount of memory access processing is performed during the execution of the image processing these days. Therefore, to improve the efficiency of image processing, it is important to increase the efficiency of memory access processing.

To increase the efficiency of memory access processing, the amount of data to be involved in one memory access processing operation needs to be reduced. A technique known for reducing the data size particularly in the field of image processing is a data encoding process that uses discrete cosine transform (DCT) to encode image data into an image code. DCT is a technique for compressing a data amount by converting image data as discrete signals into DCT coefficients that indicate which spatial frequency is included to what extent, using a spatial frequency distribution formed with horizontal and vertical two-dimensional cosine frequencies.

In the case of image processing in a digital camera, for example, RGB image data based on an object image acquired via an optical system is converted into YUV image data, and the image processing is performed in the middle of a series of processes for compressing and recording the data size. Various kinds of image processing are known. In the case of a distortion correction process for correcting image distortion through geometric transform, for example, there are many memory access processes that occur during the distortion correction process, and the amount of memory access related to this image processing is large. If the image data to be processed can be handled as an image code each time such a large amount of memory access occurs, the data amount in the memory access processing can be reduced, and accordingly, the efficiency of the processing can be increased.

In a frequency conversion process for converting image data into an image code, the vertical, horizontal, and diagonal edges in an image are recognized from output DCT coefficients, and a limiter process for switching DCT coefficient limiters is performed to encode image data into an image code.

### SUMMARY

In an aspect of the present disclosure, there is provided an encoding device configured to encode an image. The encoding device includes processing circuitry configured to generate an image block obtained by dividing the image by a predetermined number of pixels; perform a frequency conversion process on the image block, to generate a frequency conversion coefficient of each pixel in the image block; generate a quantized coefficient obtained by quantizing the frequency conversion coefficient; perform a zero bit encoding process on the quantized coefficient, to generate zero bit encoded data; and generate an image code from the zero bit encoded data.

In another aspect of the present disclosure, there is provided a decoding device configured to decode an image code into an image. The decoding device includes processing circuitry configured to analyze the image code, to identify a zero bit encoding format of the image code; generate a quantized coefficient from zero bit encoded data related to the image code, using a zero bit decoding format corresponding to the zero bit encoding format identified; perform an inverse quantization process on the quantized coefficient, to generate a frequency conversion coefficient; perform an inverse frequency conversion process on the frequency conversion coefficient, to generate an image block formed with a predetermined number of pixels; and integrate the image block generated in the inverse frequency conversion process, to generate the image.

In still another aspect of the present disclosure, there is provided an encoding method for encoding an image into image code. The encoding method includes generating an image block obtained by dividing the image by a predetermined number of pixels; performing a frequency conversion process on the image block, to generate a frequency conversion coefficient of each pixel in the image block; generating a quantized coefficient obtained by quantizing the frequency conversion coefficient; performing a zero bit encoding process on the quantized coefficient, to generate zero bit encoded data; and generating the image code from the zero bit encoded data.

In still yet another aspect of the present disclosure, there is provided a decoding method for decoding image code into an image. The decoding method includes analyzing the image code, to identify a zero bit encoding format of the image code; generating a quantized coefficient from zero bit encoded data related to the image code, using a zero bit decoding format corresponding to the zero bit encoding format identified; performing an inverse quantization process on the quantized coefficient, to generate a frequency conversion coefficient; performing an inverse frequency conversion process on the frequency conversion coefficient, to generate an image block formed with a predetermined number of pixels; and integrating the image block generated in the inverse frequency conversion process, to generate the image.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a configuration diagram illustrating an embodiment of an image forming system to which an encoding device and a decoding device according to an embodiment of the present invention can be applied;

FIG. 2 is a functional block diagram of the image forming system; FIG. 3 is a functional configuration diagram of the image processing blocks included in an encoding device according to an embodiment of the present invention;

FIG. 4 is a functional configuration diagram of the variable-length moving image compression blocks included in an encoding device according to an embodiment of the present invention;

FIG. 5 is a diagram illustrating an example of arithmetic expressions that are the algorithm of a DCT process to be used in an encoding device and a decoding device according to an embodiment of the present invention;

FIG. 6A is a diagram illustrating an example of image data to be processed by an encoding method and a decoding method according to an embodiment of the present invention;

FIG. 6B is a diagram illustrating an example of pixel blocks to be processed;

FIG. 7 is a diagram illustrating the functional blocks of an encoding device according to an embodiment of the present invention;

FIGS. 8A and 8B are diagrams illustrating an example of DCT coefficients according to an embodiment;

FIGS. 9A and 9B are diagrams illustrating an example of a quantization table according to an embodiment;

FIGS. 10A and 10B are diagrams illustrating an example of post-quantization DCT coefficients to be obtained by an encoding method according to an embodiment;

FIG. 11 is a diagram illustrating an example of a zero bit encoding table according to an embodiment;

FIGS. 12A and 12B are diagrams illustrating a first example of a zero bit encoding conversion table according to an embodiment;

FIGS. 13A and 13B are diagrams illustrating a second example of a zero bit encoding conversion table according to an embodiment;

FIGS. 14A and 14B are diagrams illustrating a third example of a zero bit encoding conversion table according to an embodiment;

FIG. 15 is a diagram illustrating an example of DCT coefficients after a zero bit encoding process according to an embodiment;

FIG. 16 is a diagram illustrating an example of the format of a fixed-length bit string generated in an encoding device according to an embodiment;

FIG. 17 is a diagram illustrating the functional blocks of a decoding device according to an embodiment of the present invention;

FIG. 18 is a diagram illustrating an example of a zero bit decoding table according to an embodiment;

FIGS. 19A and 19B are diagrams illustrating a first example of a zero bit decoding conversion table according to an embodiment;

FIGS. 20A and 20B are diagrams illustrating a second example of a zero bit decoding conversion table according to an embodiment;

FIGS. 21A and 21B are diagrams illustrating a third example of a zero bit decoding conversion table according to an embodiment;

FIG. 22 is a diagram illustrating an example of an inverse quantization table according to an embodiment;

FIGS. 23A and 23B are diagrams illustrating an example of DCT coefficients according to an embodiment;

FIG. 24 is a flowchart illustrating an embodiment of an image processing method including an encoding method and a decoding method according to an embodiment of the present invention;

FIG. 25 is a flowchart illustrating a specific embodiment of an image processing method including an encoding method and a decoding method according to an embodiment of the present invention;

FIG. 26 is a flowchart illustrating an example of an encoding method according to an embodiment;

FIG. 27 is a flowchart illustrating an example of zero bit encoding to be used in an encoding method according to an embodiment;

FIG. 28 is a flowchart illustrating a specific example of zero bit encoding to be used in an encoding method according to an embodiment;

FIG. 29 is a flowchart illustrating another specific example of zero bit encoding to be used in an encoding method according to an embodiment;

FIG. 30 is a flowchart illustrating yet another specific example of zero bit encoding to be used in an encoding method according to an embodiment;

FIG. 31 is a flowchart illustrating an example of a decoding method according to an embodiment;

FIG. 32 is a flowchart illustrating an example of zero bit decoding to be used in a decoding method according to an embodiment;

FIG. 33 is a flowchart illustrating a specific example of zero bit decoding to be used in a decoding method according to an embodiment;

FIG. 34 is a flowchart illustrating another specific example of zero bit decoding to be used in a decoding method according to an embodiment; and

FIG. 35 is a flowchart illustrating yet another specific example of zero bit decoding to be used in a decoding method according to an embodiment.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

For example, an image code such as a fixed-length bit string generated from YUV image data converted from RGB image data includes bit strings corresponding to a luminance component (the Y component) and two color difference components (the U component and the V component). With the quality of the decompressed image being taken into consideration, the bit length of the DCT component of the luminance (Y) related to a portion with unsharp edges (a portion in which the scalar quantities of the YUV components are low or medium) included in the original image needs to be equal to or greater than a certain length. Otherwise, the image after decoding will have unsharp edges. Therefore, to prevent deterioration in image quality related to the decoded image data, it is necessary to secure a certain bit length for the DCT coefficient related to the luminance of the portion related to a low to medium scalar quantity. In this case, the bit lengths of the DCT coefficients related to the U component and the V component need be shortened. However, if the bit lengths of the DCT coefficients related to the U component and the V component are shortened (if the data amount is reduced), the color reproducibility is degraded in the decoded image.

By a conventional technique, edges are roughly classified into the three types, which are vertical, horizontal, and diagonal edges, on the basis of DCT coefficients. By this technique, it is difficult to fully recognize the characteristics of each edge. Further, by the conventional technique, the limit values (limiters) that limits DCT coefficients are set at the same value, regardless of the scalar quantities of the DCT coefficients. Therefore, the same limiter processing is performed on the DCT coefficients. Related arts have problems in the reproducibility of edges included in images after decoding.

In other words, even if the conventional technique is used, it is still difficult to prevent deterioration in image quality while achieving a high compression rate for reducing the amount of memory access in image processing.

### SUMMARY OF THE INVENTION

An encoding device according to an embodiment of the present invention is a device that performs an encoding process for converting image data into an image code such as a fixed-length bit string by applying a frequency conversion process using discrete cosine transform (DCT). A decoding device according to an embodiment of the present invention corresponds to the encoding device, and is a device that decodes an image code such as a fixed-length bit string into image data. Hereinafter, a discrete cosine transform process will be referred to as a “DCT process”. A coefficient obtained through a DCT process will be referred to as a “DCT coefficient”.

A device according to an embodiment of the present invention converts (encodes) a DCT coefficient generated from image data into an image code such as a 144-bit fixed-length bit string. By doing so, the device reduces the amount of data related to the memory access process at the time of image processing, and lowers the costs for memory access. Furthermore, as the present invention is applied to an application specific integrated circuit (ASIC) that performs image processing, the consumption of electric current by the ASIC can also be reduced. Accordingly, the cooling mechanism of the ASIC can be simplified, and the costs for manufacturing an image processing apparatus can be lowered.

An encoding method and a decoding method implemented in an encoding device and a decoding device according to an embodiment of the present invention are characterized by a process included in a process of dividing an image into image blocks each formed with a predetermined number of pixels, and encoding the DCT coefficients corresponding to the image blocks into image codes such as fixed-length bit strings. More specifically, in a process of reducing the number of bits by quantizing a DCT coefficient, the degree of reduction of the number of bits is made lower than that in a conventional process, and thus, the decompressibility is increased. A “zero bit encoding” process is performed on a DCT coefficient bit string, to achieve the same data compression rate as that in conventional cases. In other words, it is possible to make the image quality of a decompressed image higher than that in conventional cases, while increasing the efficiency of data access processes. In the description below, embodiments of the present invention that implement these features will be described.

Embodiment of an Apparatus Including an Encoding Device/a Decoding Device According to the Present Invention

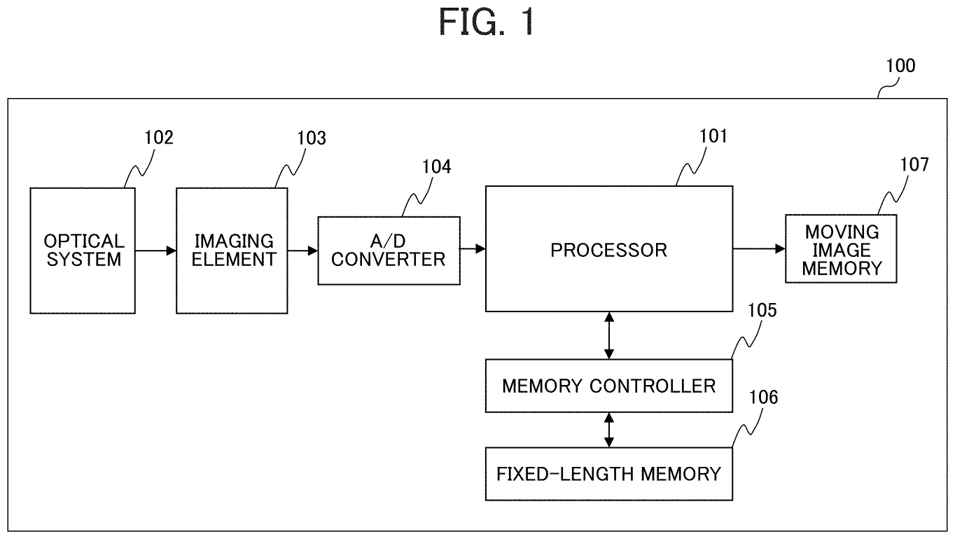

An encoding device and a decoding device according to the present invention can be applied to an image processing system that captures and records an image, for example. FIG. 1 illustrates an example configuration of an image processing system for explaining an embodiment of an encoding device and a decoding device according to the present invention. In the description below, an image processing system according to this embodiment is a digital camera 100 having a function of capturing and recording an object image.

The digital camera 100 according to this embodiment includes an optical system 102, an imaging element 103, an analog/digital (A/D) converter 104, a processor 101 that performs image processing, a memory controller 105, a fixed-length memory 106, and a moving image memory 107.

The optical system 102 includes an optical lens that forms an object image on the imaging surface of the imaging element 103. The optical lens included in the optical system 102 is a wide-angle lens, for example. If two such optical lenses are provided, it is also possible to condense the light reflected from objects located in a 360-degree range. In other words, omnidirectional object images can be gathered into one set of image data via the optical system 102.

The imaging element 103 is a photoelectric conversion element that converts object light collected by the optical system 102 into an electrical signal, and outputs the image signal at predetermined time intervals, as appropriate. The imaging element 103 may be a solid-state imaging element such as a charge coupled device (CCD) sensor or a complementary metal oxide semiconductor (CMOS) sensor, for example.

The A/D converter 104 performs digital-to-digital conversion on the image signal output from the imaging element 103, and outputs the converted signal as image data to the processor 101, as appropriate. This image data is to be the target of image processing to be performed by the processor 101 in a later stage.

The processor 101 that includes an arithmetic processing unit and a storage area like a computer is an application specific integrated circuit (ASIC), for example, and performs image processing including a geometric transform process such as a distortion correction process. When performing image processing, the processor 101 also performs an encoding process for converting image data into a fixed-length bit string, and a decoding process for decompressing image data from a fixed-length bit string.

The memory controller 105 controls a data storing operation when storing a fixed-length bit string generated by the processor 101 performing image processing into the fixed-length memory 106. The memory controller 105 also controls an operation to read a fixed-length bit string stored in the fixed-length memory 106 when the processor 101 performs image processing.

The fixed-length memory 106 is a nonvolatile memory that stores/reads the fixed-length bit string to be used in image processing to be performed by the processor 101, under the control of the memory controller 105. The fixed-length memory 106 may be a double-data-rate synchronous dynamic random access memory (DDR-SDRAM), for example. The fixed-length memory 106 functions as a work memory that temporarily stores the data to be processed when predetermined image processing is performed.

The moving image memory 107 is a nonvolatile memory that stores a moving image generated by the processor 101 performing image processing. The moving image memory 107 may be a flash memory, for example.

Functional Blocks of the Processor

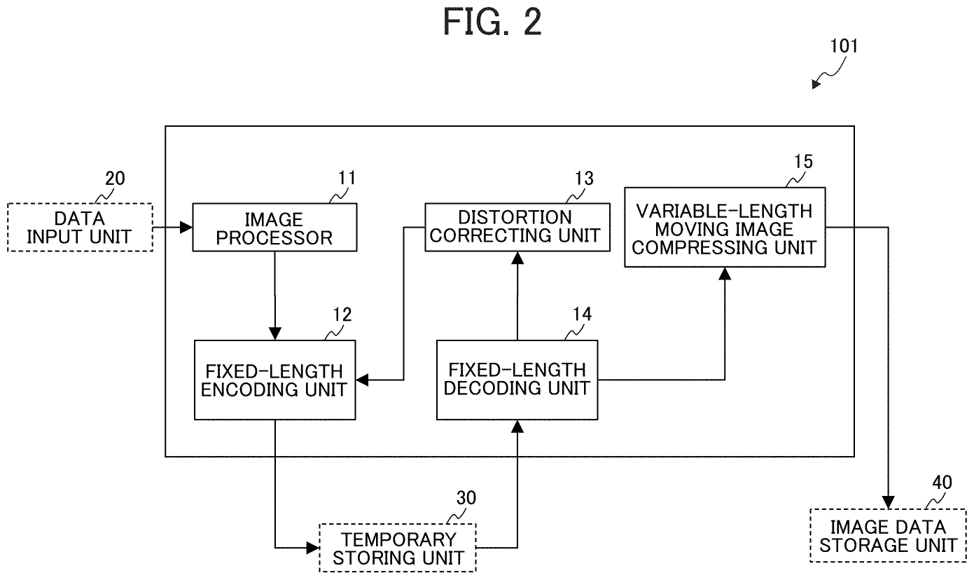

Next, the functional blocks of the processor 101 are described in detail. As illustrated in FIG. 2, the image processing blocks formed by the processor 101 includes an image processor 11, a fixed-length encoding unit 12, a distortion correcting unit 13, a fixed-length decoding unit 14, and a variable-length moving image compressing unit 15. Each functional block relating to the processor 101 is implemented by cooperation between an image processing program including an encoding program and a decoding program according to the present invention and the hardware resources of the processor 101.

The image processor 11 performs image processing for converting image data output from a data input unit 20 formed with the optical system 102, the imaging element 103, and the A/D converter 104, into RGB image data. The image processor 11 generates RGB image data, and outputs the RGB image data to the fixed-length encoding unit 12. The image processor 11 will be described later in detail.

The fixed-length encoding unit 12 performs a fixed-length encoding process on the RGB image data generated by the image processor 11. By doing so, the fixed-length encoding unit 12 generates a fixed-length bit string from the RGB image data. The fixed-length encoding unit 12 also performs a fixed-length encoding process on corrected image data (corrected RGB image data) generated by the distortion correcting unit 13. The fixed-length encoding unit 12 transfers the fixed-length bit string converted from the corrected RGB image data to a temporary storing unit 30. At this stage, an instruction is given to write the corrected fixed-length bit string at an address designated by the distortion correcting unit 13. The fixed-length encoding unit 12 will be described later in detail. The fixed-length encoding unit 12 corresponds to an embodiment of an encoding device according to the present invention.

The temporary storing unit 30 is formed with the memory controller 105 and the fixed-length memory 106 that operate under the control of the processor 101.

The distortion correcting unit 13 reads image data that is generated by the fixed-length decoding unit 14 decoding a yet-to-be-corrected fixed-length bit string stored in the temporary storing unit 30, and then performs a distortion correction process. The distortion correcting unit 13 transfers the corrected image data generated through the distortion correction process, to the fixed-length encoding unit 12.

The fixed-length decoding unit 14 reads, from the temporary storing unit 30, a fixed-length bit string designated from the distortion correcting unit 13, decodes the fixed-length bit string, and transfers the result to the distortion correcting unit 13. The fixed-length decoding unit 14 also sequentially reads and decodes corrected fixed-length bit strings, and transfers the results to the variable-length moving image compressing unit 15. The fixed-length decoding unit 14 will be described later in detail. The fixed-length decoding unit 14 corresponds to an embodiment of a decoding device according to the present invention.

The variable-length moving image compressing unit 15 performs a moving image compression process on corrected RGB image data transferred from the fixed-length decoding unit 14. Through a process performed in the variable-length moving image compressing unit 15, a moving image compression process of Moving Picture Experts Group (MPEG) is performed, for example. The variable-length moving image compressing unit 15 transfers the moving image data generated through the moving image compression process to an image data storage unit 40 formed with the moving image memory 107. The variable-length moving image compressing unit 15 will be described later in detail.

Specific Functional Blocks of the Image Processor

Referring now to FIG. 3, the functional blocks of the image processor 11 according to this embodiment are described in detail. As illustrated in FIG. 3, the image processor 11 includes a Bayer correction processing unit 111 and a filter processing unit 112.

The Bayer correction processing unit 111 receives image data from the data input unit 20, reads and corrects a Bayer image, and generates normal RGB values.

The filter processing unit 112 performs a filtering process on the RGB image data generated by the Bayer correction processing unit 111. The RGB image data subjected to the filtering process is transferred to the fixed-length encoding unit 12.

Specific Functional Blocks of the Variable-Length Moving Image Compressing Unit

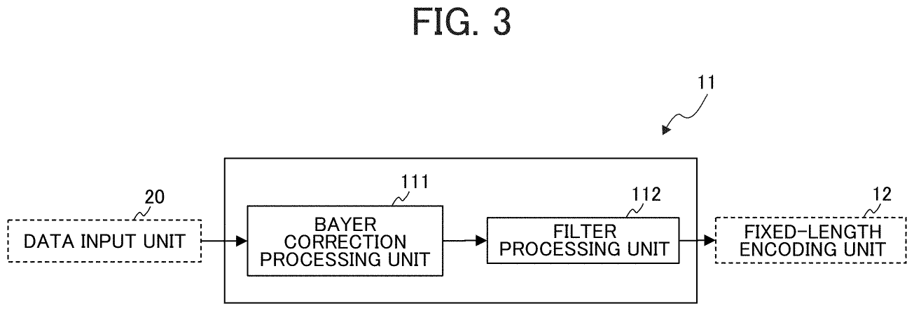

Referring now to FIG. 4, the functional blocks of the variable-length moving image compressing unit 15 according to this embodiment are described in detail. As illustrated in FIG. 4, the variable-length moving image compressing unit 15 includes a motion searching unit 151, a DCT unit 152, a quantization processing unit 153, a variable-length encoding unit 154, an inverse quantization processing unit 155, an inverse DCT unit 156, and a motion compensating unit 157.

The motion searching unit 151 calculates difference data between image data received from the fixed-length decoding unit 14 and the block of the previous frame having the highest correlation from the motion compensating unit 157.

The DCT unit 152 performs a DCT process for converting the difference data calculated by the motion searching unit 151 into a spatial frequency, and transfers the spatial frequency to the quantization processing unit 153.

The quantization processing unit 153 quantizes the frequency-converted DCT coefficient, and transfers the result to the variable-length encoding unit 154.

The variable-length encoding unit 154 performs variable-length encoding on the quantized data generated by the quantization processing unit 153, to generate a compression code. The variable-length encoding unit 154 stores the generated compression code into the image data storage unit 40.

The inverse quantization processing unit 155 performs an inverse quantization process on the “quantized block” generated by the quantization processing unit 153. The inverse quantization processing unit 155 transfers the processing result to the inverse DCT unit 156.

The inverse DCT unit 156 performs an inverse frequency conversion process (an inverse DCT process) on the inversely quantized data transferred from the inverse quantization processing unit 155. The inverse DCT unit 156 transfers the result of the processing performed in the inverse frequency conversion process to the motion compensating unit 157.

The motion compensating unit 157 adds the difference data transferred from the inverse DCT unit 156 to the macroblock of the previous frame subjected to motion compensation, to create a reference frame. The motion compensating unit 157 transfers the reference frame to the motion searching unit 151.

DCT Process/Inverse DCT Process

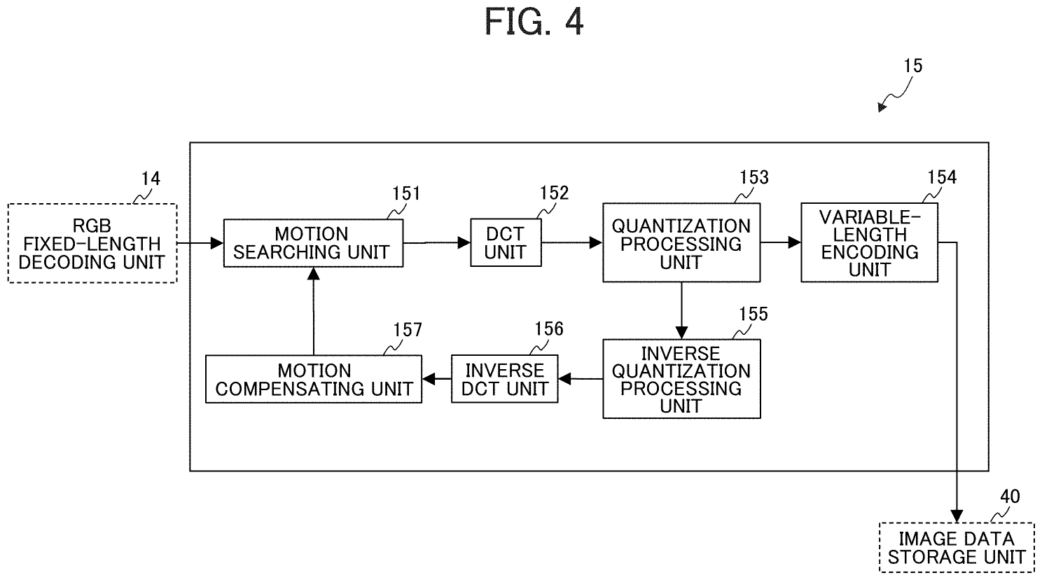

A frequency conversion process (a DCT process) for converting image data into a DCT coefficient, and an inverse frequency conversion process (an inverse DCT process) for converting a DCT coefficient into image data are now described. The frequency conversion process and the inverse frequency conversion process are used in this embodiment. FIG. 5 illustrates arithmetic expressions of example algorithms for a DCT process and an inverse DCT process according to this embodiment. The DCT process according to this embodiment is a process for generating a DCT coefficient for each pixel in an image block obtained by dividing image data by a predetermined number of pixels. Further, the inverse DCT process according to this embodiment is a process for decompressing image data for each pixel from a DCT coefficient.

Examples of Original Image Data and a Fixed-Length Code

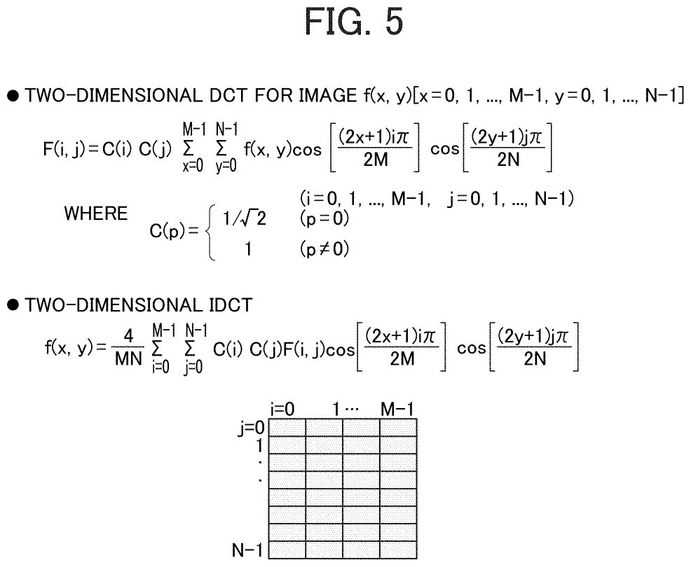

Next, the relationship between the image data to be processed in image processing according to this embodiment and the fixed-length bit string related to the image data is described, with reference to schematic diagrams illustrated in FIGS. 6A and 6B. FIG. 6A schematically illustrates original image data 201 to be subjected to image processing. The original image data 201 is formed with a plurality of pixels. FIG. 6B schematically illustrates an image block obtained by dividing the original image data 201 into a predetermined number of pixels (four pixels×four pixels, for example).

The original image data 201 relating to an object captured by the digital camera 100 is divided into image blocks 202 formed with four pixels×four pixels, and an image block 202 as illustrated in FIG. 6B is set as a unit of processing of a fixed-length bit string. Therefore, a fixed-length bit string according to this embodiment is based on values generated for the respective image blocks 202 formed with four pixels×four pixels of the original image data 201.

Embodiment of an Encoding Device

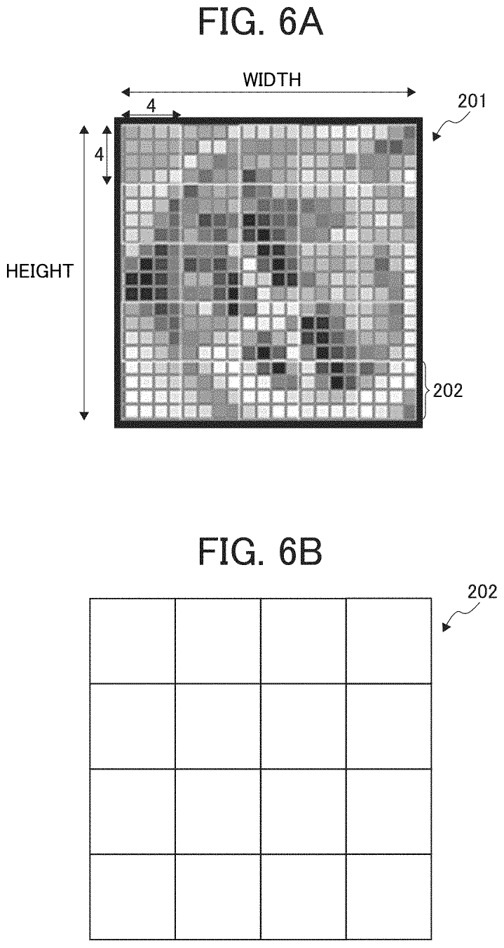

Next, the functional blocks of the fixed-length encoding unit 12 corresponding to an embodiment of an encoding device according to the present invention are described in greater detail. As illustrated in FIG. 7, the fixed-length encoding unit 12 according to this embodiment includes a blocking unit 121, a YUV conversion unit 122, a DCT conversion unit 123, a quantization unit 124, a quantization table 125, a zero bit encoding processing unit 126, a zero bit encoding table 127, and an encoding format generating unit 128.

The blocking unit 121 divides RGB image data received from the image processor 11 into image blocks 202 formed with four pixels×four pixels. An image of an image block 202 is as described above with reference to FIGS. 6A and 6B. The blocking unit 121 corresponds to an image dividing means, and forms an image dividing unit.

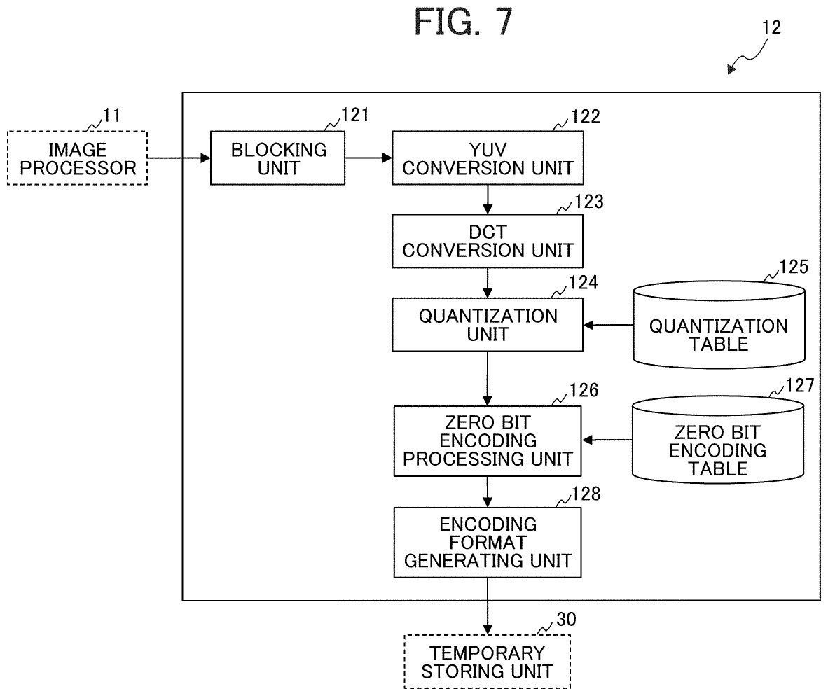

The YUV conversion unit 122 performs a YUV conversion process on the image blocks 202 transferred from the blocking unit 121. By doing so, the YUV conversion unit 122 generates a YUV image block 300 (see FIG. 8) formed with four pixels×four pixels. The YUV image block 300 is transferred from the YUV conversion unit 122 to the DCT conversion unit 123.

The DCT conversion unit 123 performs a DCT process on the YUV image block 300, to generate DCT coefficients of the respective pixels constituting the YUV image block 300. The DCT conversion unit 123 transfers the generated DCT coefficients to the quantization unit 124. The DCT conversion unit 123 corresponds to a frequency conversion means, and forms a frequency conversion unit. The DCT conversion unit 123 will be described later in detail.

The quantization unit 124 refers to the quantization table 125, and obtains quantization shift values corresponding to the respective pixel blocks of a DCT coefficient block 310 received from the DCT conversion unit 123. The quantization table 125 stores table data that includes the quantization shift values to be used in a quantization process at the quantization unit 124. The quantization unit 124 and the quantization table 125 will be described later in detail.

Regarding a bit string of DCT coefficients relating to the respective blocks of the DCT coefficient block transferred from the quantization unit 124 after quantization, the zero bit encoding processing unit 126 refers to the zero bit encoding table 127, to determine the processing pattern in a zero bit encoding process. On the basis of the zero bit encoding format defined by the determined processing pattern, the zero bit encoding processing unit 126 also performs a zero bit encoding process, and transfers the result to the encoding format generating unit 128. The contents of the processing at the zero bit encoding processing unit 126 will be described later in detail.

The zero bit encoding table 127 stores a zero bit encoding bit number conversion table 700 to be used by the zero bit encoding processing unit 126. The zero bit encoding table 127 also stores a plurality of zero bit encoding formats. The zero bit encoding formats and the like will be described later in detail.

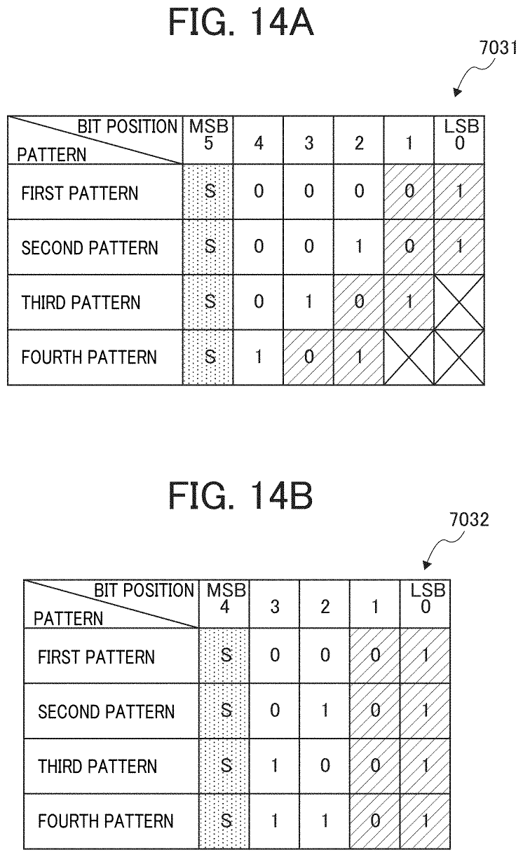

On the basis of the zero bit encoding format transferred from the zero bit encoding processing unit 126, the encoding format generating unit 128 performs a format conversion process to conduct conversion into a format illustrated in FIG. 15. The encoding format generating unit 128 stores the fixed-length bit string generated through the format conversion process, into the fixed-length memory 106 forming the temporary storing unit 30. The encoding format generating unit 128 corresponds to an encoding means. The fixed-length bit string format will be described later in detail.

Details of the DCT Conversion Unit

Examples of DCT coefficients generated at the DCT conversion unit 123 are now schematically illustrated. The examples illustrated in FIGS. 8A and 8B schematically show DCT coefficients that are generated depending on the differences in spatial frequency in the respective pixels constituting a YUV image block 300.

For example, as illustrated in FIG. 8A, the DCT coefficients related to the respective blocks are calculated as values such as [255], [10], and [−125].

FIG. 8B illustrates a DCT coefficient block 310 indicating the bit length of the DCT coefficients calculated for the respective pixel blocks as a result of a DCT process performed on the YUV image block 300 by the DCT conversion unit 123. As illustrated in FIG. 8B, in this embodiment, the bit length of the calculated DCT coefficient is 10 bits in all the pixel blocks.

In other words, the DCT coefficient values vary among the pixel blocks of the DCT coefficient block 310, but the bit length is 10 bits. The DCT coefficient block 310 is generated by the DCT conversion unit 123, and is transferred to the quantization unit 124.

Details of the Quantization Unit and the Quantization Table

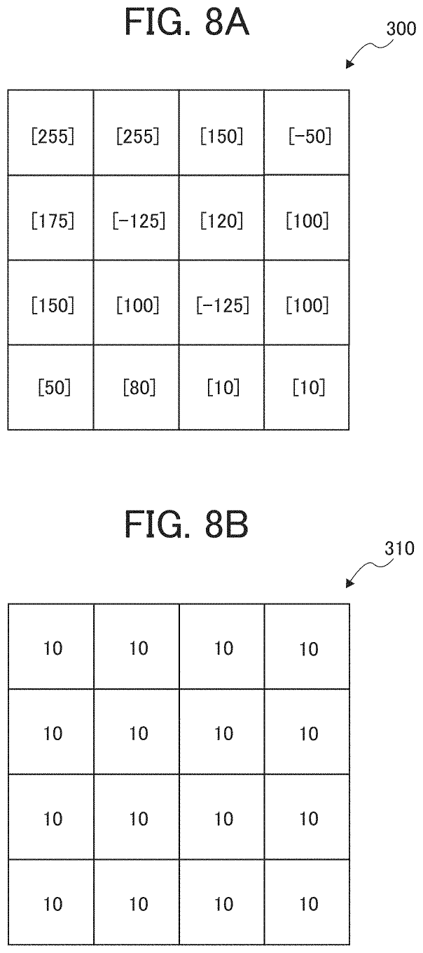

FIG. 9A illustrates an example of a quantization shift value table 501 stored in the quantization table 125. FIG. 9B illustrates a quantization shift value table 502 as a conventional example for comparison.

In FIGS. 9A and 9B, examples of the bit shift values corresponding to the respective blocks of the DCT coefficient block 310 are shown. However, “0” in the blocks denoted by reference numeral 501a does not mean that “the bit shift amount is zero”, but means that the block is not to be subjected to processing for generating a fixed-length bit string. These blocks correspond to portions at which the DCT coefficients are small, because many of the pixels corresponding to the YUV image block 300 have high spatial frequency. Even if a fixed-length bit string is generated without such pixels, the fixed-length bit string is excluded from the processing target because the influence on the image quality in a decompressed image is small.

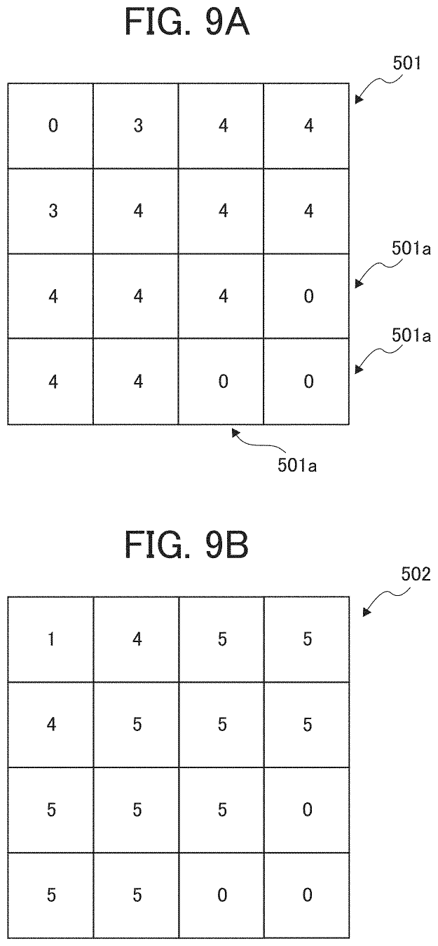

FIG. 10A illustrates an example of a post-quantization DCT coefficient block 511 that shows the DCT coefficients obtained after a quantization process using the quantization shift value table 501 illustrated in FIG. 9A is performed in the quantization unit 124. The bit lengths of the DCT coefficients of the respective blocks of the post-quantization DCT coefficient block 511 vary depending on the shift values in the quantization shift value table 501. For comparison, FIG. 10B illustrates an example of a post-quantization DCT coefficient block 512 relating to a quantization process using the conventional quantization shift value table 502 illustrated in FIG. 9B.

Comparison between FIG. 10A and FIG. 10B shows that the quantization process at the quantization unit 124 according to this embodiment have smaller shift values than those of the conventional quantization process, and therefore, the bit lengths of the respective blocks of the post-quantization DCT coefficient block 511 are longer. This means that, at the stage of the quantization process, the data compression rate in this embodiment is lower than that in the conventional case. In this embodiment, however, the image data is decompressed with the DCT coefficients based on the bit lengths shown in the post-quantization DCT coefficient block 511. Thus, the image quality after the decompression becomes higher than that in the conventional comparative example. The post-quantization DCT coefficient block 511 is transferred from the quantization unit 124 to the zero bit encoding processing unit 126.

Details of the Zero Bit Encoding Bit Number Conversion Table

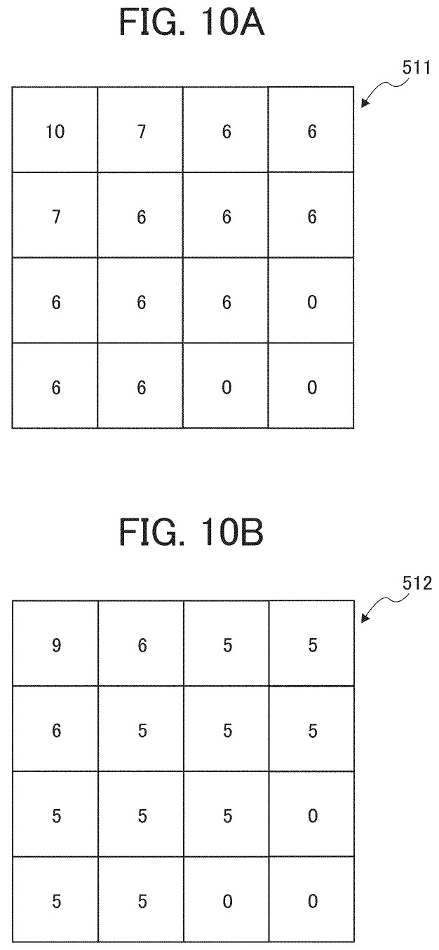

FIG. 11 illustrates an example of the zero bit encoding bit number conversion table 700. The zero bit encoding bit number conversion table 700 defines the processing patterns in the zero bit encoding processes corresponding to the respective blocks of the post-quantization DCT coefficient block 511. For example, a first encoding processing pattern 701 is executed for the post-quantization DCT coefficient block 511 corresponding to “10->9”. The first encoding processing pattern 701 is a zero bit encoding process that changes a bit string that is 10 bits long to a bit string that is nine bits long.

Likewise, a second encoding processing pattern 702 is executed for the post-quantization DCT coefficient block 511 corresponding to “7->6”. The second encoding processing pattern 702 is a zero bit encoding process that changes a bit string that is seven bits long to a bit string that is six bits long. A third encoding processing pattern 703 is executed for the post-quantization DCT coefficient block 511 corresponding to “6->5”. The third encoding processing pattern 703 is a zero bit encoding process that changes a bit string that is six bits long to a bit string that is five bits long.

Next, the zero bit encoding processes to be performed by the zero bit encoding processing unit 126 are described in detail. The zero bit encoding processing unit 126 refers to the zero bit encoding table 127, to determine a zero bit encoding format for the block to be processed, and determine a plurality of bit arithmetic processes included in the determined zero bit encoding format.

First Encoding Processing Pattern

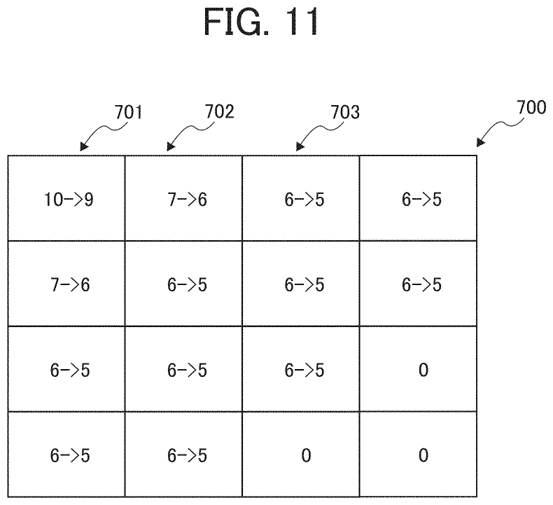

FIGS. 12A and 12B are tables for explaining the first encoding processing pattern 701. FIG. 12A illustrates an example of bit strings of post-quantization DCT coefficients before a zero bit encoding process is performed with the first encoding processing pattern 701. FIG. 12B illustrates an example of bit strings after a zero bit encoding process is performed with the first encoding processing pattern 701.

As illustrated in FIG. 12A, a specific processing pattern is determined from a plurality of processing patterns in the zero bit encoding process type selected in accordance with the positions of the pixel blocks. In a bit string before a zero bit encoding process (a first pre-encoding bit string 7011), the 9th bit, which is the most significant bit (MSB), is the sign bit (S bit). In a case where the first pre-encoding bit string 7011 is searched sequentially from the highest bit after the MSB, and three “0”s appear in a row, the processing pattern for this bit string is a first pattern.

Likewise, in a case where the first pre-encoding bit string 7011 is searched sequentially from the highest bit after the MSB, and three “0”s do not appear in a row, but “1” appears after two “0”s appear in a row, the processing pattern for this bit string is a second pattern. In a case where the first pre-encoding bit string 7011 is searched sequentially from the highest bit after the MSB, and three “0”s do not appear in a row, but “1” appears after one “0”, the processing pattern for this bit string is a third pattern. Further, in a case where the first pre-encoding bit string 7011 is searched sequentially from the highest bit after the MSB, and one “1” appears before any “0” appears, the processing pattern for this bit string is a fourth pattern.

The results of zero bit encoding processes based on the processing patterns determined as described above are now described, with reference to a first post-encoding bit string 7012 in FIG. 12B. In the case of the first pattern, “000” from the 8th bit to the 6th bit is changed to “00”, which is then set at the 7th bit and the 6th bit in the first post-encoding bit string 7012. The six bits from the 5th bit to the LSB of the first pre-encoding bit string 7011 are assigned to the six bits from the 5th bit to the LSB of the first post-encoding bit string 7012.

In the case of the second pattern, “001” from the 8th bit to the 6th bit is changed to “01”, which is then set at the 7th bit and the 6th bit in the first post-encoding bit string 7012. The six bits from the 5th bit to the LSB of the first pre-encoding bit string 7011 are assigned to the six bits from the 5th bit to the LSB of the first post-encoding bit string 7012.

In the case of the third pattern, the 8th and 7th bits are “01”, and accordingly, “10” is set at the 7th bit and the 6th bit in the first post-encoding bit string 7012. Further, the six bits from the 6th bit to the 1st bit of the first pre-encoding bit string 7011 are assigned to the six bits from the 5th bit to the LSB of the first post-encoding bit string 7012. In other words, the lower six bits of the first pre-encoding bit string 7011 are shifted to the right by one bit, and the shifted six bits are assigned to the six bits from the 5th bit to the LSB of the first post-encoding bit string 7012.

In the case of the fourth pattern, the 8th bit is “1”, and accordingly, “11” is set at the 7th bit and the 6th bit in the first post-encoding bit string 7012. Further, the six bits from the 7th bit to the 2nd bit of the first pre-encoding bit string 7011 are assigned to the six bits from the 5th bit to the LSB of the first post-encoding bit string 7012. In other words, the lower seven bits of the first pre-encoding bit string 7011 are shifted to the right by two bits, and are then assigned to the bits from the 5th bit to the LSB of the first post-encoding bit string 7012.

In the format of the first post-encoding bit string 7012 in a zero bit encoding process, the MSB is the “sign bit (S)”, and the next highest two bits form the “zero bit header” that clearly indicates the zero bit processing pattern. The post-quantization DCT coefficients are then stored into the six bits from the bit after the zero bit header to the LSB. In the above manner, a bit string that is 10 bits long in the first encoding processing pattern 701 can be compressed to nine bits long.

Second Encoding Processing Pattern

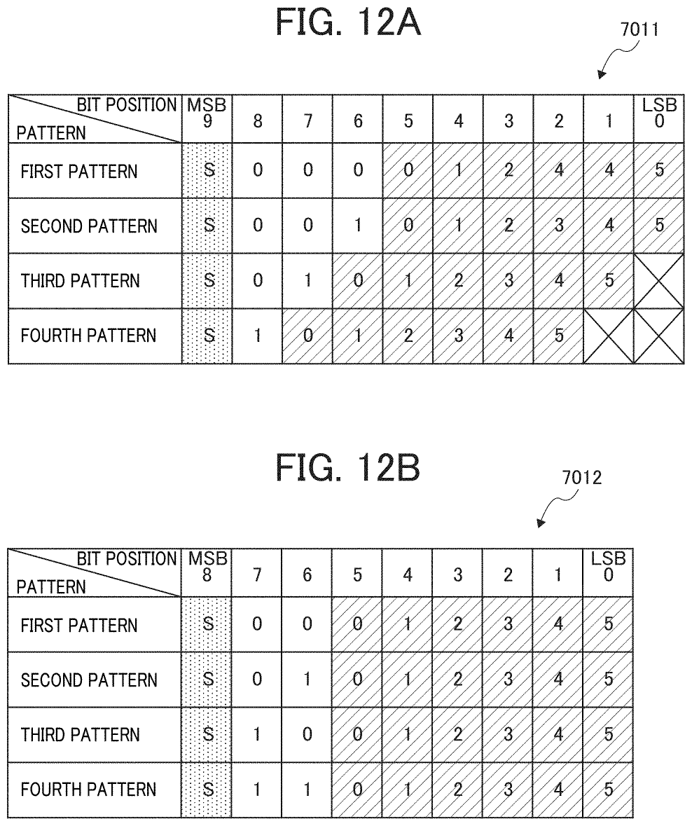

FIGS. 13A and 13B are tables for explaining the second encoding processing pattern 702. FIG. 13A illustrates an example of bit strings of post-quantization DCT coefficients before a zero bit encoding process is performed with the second encoding processing pattern 702. FIG. 13B illustrates an example of bit strings after a zero bit encoding process is performed with the second encoding processing pattern 702.

As illustrated in FIG. 13A, a specific processing pattern is determined from a plurality of processing patterns depending on the magnitudes of the post-quantization DCT coefficients in the zero bit encoding process type selected in accordance with the positions of the pixel blocks. In a bit string before a zero bit encoding process (a second pre-encoding bit string 7021), the 6th bit, which is the most significant bit (MSB), is the sign bit (S bit). In a case where the second pre-encoding bit string 7021 is searched sequentially from the highest bit after the MSB, and three “0”s appear in a row, the processing pattern for this bit string is a first pattern.

Likewise, in a case where the second pre-encoding bit string 7021 is searched sequentially from the highest bit after the MSB, and three “0”s do not appear in a row, but “1” appears after two “0”s appear in a row, the processing pattern for this bit string is a second pattern. In a case where the second pre-encoding bit string 7021 is searched sequentially from the highest bit after the MSB, and three “0”s do not appear in a row, but “1” appears after one “0”, the processing pattern for this bit string is a third pattern. Further, in a case where the second pre-encoding bit string 7021 is searched sequentially from the highest bit after the MSB, and one “1” appears before any “0” appears, the processing pattern for this bit string is a fourth pattern.

The results of zero bit encoding processes based on the processing patterns determined as described above are now described, with reference to a second post-encoding bit string 7022 in FIG. 13B. In the case of the first pattern, “000” from the 5th bit to the 3rd bit is changed to “00”, which is then set at the 4th bit and the 3rd bit in the second post-encoding bit string 7022. The three bits from the 2nd bit to the LSB of the second pre-encoding bit string 7021 are assigned to the three bits from the 2nd bit to the LSB of the second post-encoding bit string 7022.

In the case of the second pattern, “001” from the 5th bit to the 3rd bit is changed to “01”, which is then set at the 4th bit and the 3rd bit in the second post-encoding bit string 7022. The three bits from the 2nd bit to the LSB of the second pre-encoding bit string 7021 are assigned to the three bits from the 2nd bit to the LSB of the second post-encoding bit string 7022.

In the case of the third pattern, the 5th and 4th bits are “01”, and accordingly, “10” is set at the 4th bit and the 3rd bit in the second post-encoding bit string 7022. Further, the three bits from the 3rd bit to the 1st bit of the second pre-encoding bit string 7021 are assigned to the three bits from the 2nd bit to the LSB of the second post-encoding bit string 7022. In other words, the lower four bits of the second pre-encoding bit string 7021 are shifted to the right by one bit, and are then assigned to the bits from the 2nd bit to the LSB of the second post-encoding bit string 7022.

In the case of the fourth pattern, the 5th bit is “1”, and accordingly, “11” is set at the 4th bit and the 3rd bit in the second post-encoding bit string 7022. Further, the three bits from the 4th bit to the 2nd bit of the second pre-encoding bit string 7021 are assigned to the three bits from the 2nd bit to the LSB of the second post-encoding bit string 7022. In other words, the lower five bits of the second pre-encoding bit string 7021 are shifted to the right by two bits, and are then assigned to the bits from the 2nd bit to the LSB of the second post-encoding bit string 7022.

In the format of the second post-encoding bit string 7022 in a zero bit encoding process, the MSB is the “sign bit (S)”, and the next highest two bits form the “zero bit header” that clearly indicates the zero bit processing pattern. The post-quantization DCT coefficients are then stored into the bit string from the bit after the zero bit header to the LSB. In the above manner, a bit string that is seven bits long in the second encoding processing pattern 702 can be compressed to six bits long.

Third Encoding Processing Pattern

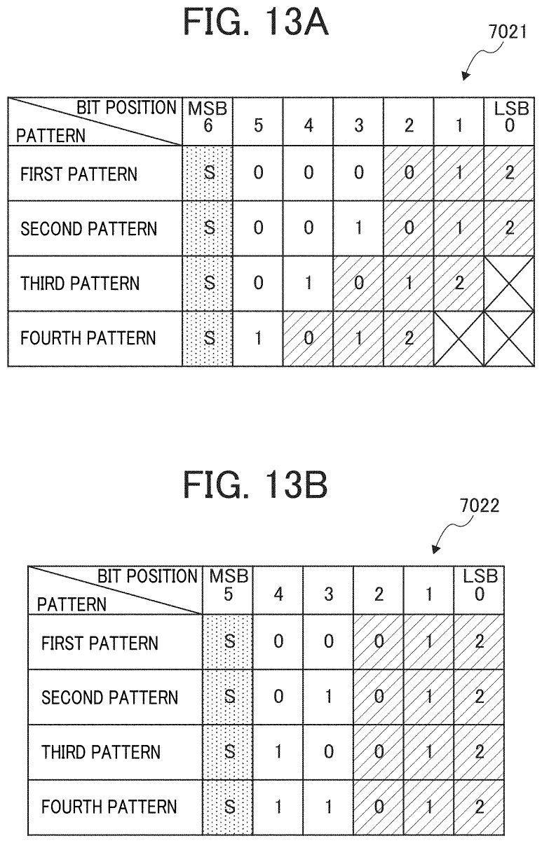

FIGS. 14A and 14B are tables for explaining the third encoding processing pattern 703. FIG. 14A illustrates an example of bit strings of post-quantization DCT coefficients before a zero bit encoding process is performed with the third encoding processing pattern 703. FIG. 14B illustrates an example of bit strings after a zero bit encoding process is performed with the third encoding processing pattern 703.

As illustrated in FIG. 14A, a specific processing pattern is determined from a plurality of processing patterns depending on the magnitudes of the post-quantization DCT coefficients in the zero bit encoding process type selected in accordance with the positions of the pixel blocks. In a bit string before a zero bit encoding process (a third pre-encoding bit string 7031), the 5th bit, which is the most significant bit (MSB), is the sign bit (S bit). In a case where the third pre-encoding bit string 7031 is searched sequentially from the highest bit after the MSB, and three “0”s appear in a row, the processing pattern for this bit string is a first pattern.

Likewise, in a case where the third pre-encoding bit string 7031 is searched sequentially from the highest bit after the MSB, and three “0”s do not appear in a row, but “1” appears after two “0”s appear in a row, the processing pattern for this bit string is a second pattern. In a case where the third pre-encoding bit string 7031 is searched sequentially from the highest bit after the MSB, and three “0”s do not appear in a row, but “1” appears after one “0”, the processing pattern for this bit string is a third pattern. Further, in a case where the third pre-encoding bit string 7031 is searched sequentially from the highest bit after the MSB, and one “1” appears before any “0” appears, the processing pattern for this bit string is a fourth pattern.

The results of zero bit encoding processes based on the processing patterns determined as described above are now described, with reference to a third post-encoding bit string 7032 in FIG. 14B. In the case of the first pattern, “000” from the 4th bit to the 2nd bit is changed to “00”, which is then set at the 3rd bit and the 2nd bit in the third post-encoding bit string 7032. The two bits from the 1st bit to the LSB of the third pre-encoding bit string 7031 are assigned to the two bits from the 1st bit to the LSB of the third post-encoding bit string 7032.

In the case of the second pattern, “001” from the 4th bit to the 2nd bit is changed to “01”, which is then set at the 3rd bit and the 2nd bit in the third post-encoding bit string 7032. The two bits from the 1st bit to the LSB of the third pre-encoding bit string 7031 are assigned to the two bits from the 1st bit to the LSB of the third post-encoding bit string 7032.

In the case of the third pattern, the 4th and 3rd bits are “01”, and accordingly, “10” is set at the 4th bit and the 3rd bit in the third post-encoding bit string 7032. Further, the two bits from the 2nd bit to the 1st bit of the third pre-encoding bit string 7031 are assigned to the two bits from the 1st bit to the LSB of the third post-encoding bit string 7032. In other words, the lower three bits of the third pre-encoding bit string 7031 are shifted to the right by one bit, and are then assigned to the 1st bit and the LSB of the third post-encoding bit string 7032.

In the case of the fourth pattern, the 4th bit is “1”, and accordingly, “11” is set at the 3rd bit and the 2nd bit in the third post-encoding bit string 7032. Further, the two bits from the 3rd bit to the 2nd bit of the third pre-encoding bit string 7031 are assigned to the two bits from the 1st bit to the LSB of the third post-encoding bit string 7032. In other words, the lower four bits of the third pre-encoding bit string 7031 are shifted to the right by two bits, and are then assigned to the 1st bit to the LSB of the third post-encoding bit string 7032.

In the format of the third post-encoding bit string 7032 in a zero bit encoding process, the MSB is the “sign bit (S)”, and the next highest two bits form the “zero bit header” that clearly indicates the zero bit processing pattern. The post-quantization DCT coefficients are then stored into the bit string from the bit after the zero bit header to the LSB. In the above manner, a bit string that is six bits long in the third encoding processing pattern 703 can be compressed to five bits long.

Although examples of zero bit encoding formats according to this embodiment and the processing patterns have been described, the zero bit encoding formats and the processing patterns that can be applied to the zero bit encoding processing unit 126 according to this embodiment are limited to those examples. For example, a processing pattern for compressing nine bits to eight bits may also be used.

Any processing pattern is determined depending on how “0” is stored in the highest three bits after the MSB in the bit string of post-quantization DCT coefficients. In other words, the contents of an encoding process are defined by the storage pattern of “0” bits.

FIG. 15 illustrates an example of a post-zero-bit DCT coefficient block 521 after the above zero bit encoding process is performed on the post-quantization DCT coefficient block 511. The numbers in the respective blocks of the post-zero-bit DCT coefficient block 521 indicate the bit lengths of the respective DCT coefficients after a data compression process is performed on the basis of the zero bit encoding table 127. Comparison between FIG. 15 and FIG. 10B shows that the bit lengths in each block are the same.

Through an encoding process according to this embodiment, the compression rate at the stage of DCT coefficient quantization is reduced to improve the image quality at the time of decompression, and a fixed-length bit string can be generated at a data compression rate equal to a conventional one through a zero bit encoding process.

Details of a Fixed-Length Bit String Format

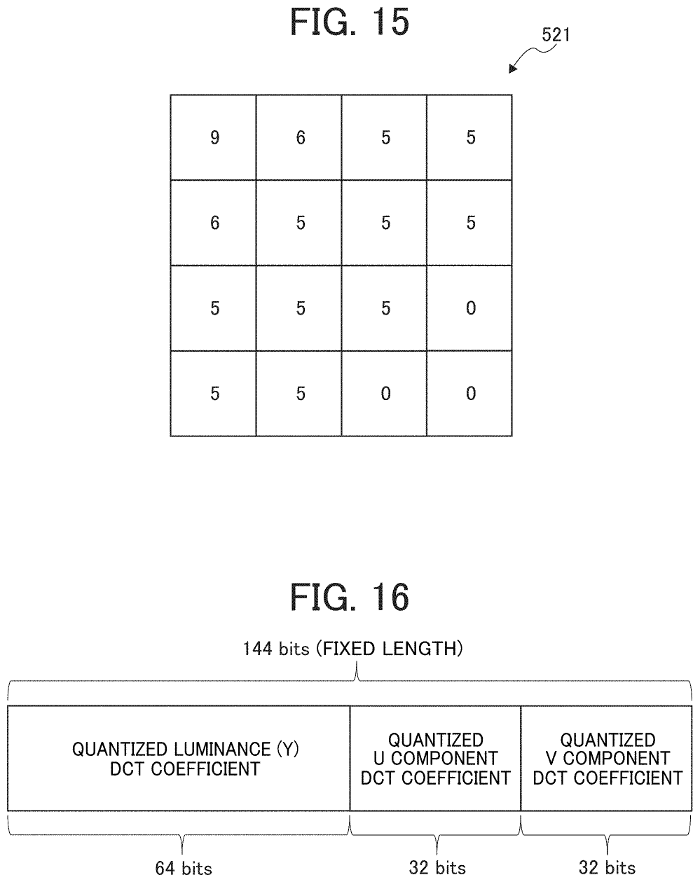

FIG. 16 illustrates an example of the format of fixed-length bit string (a fixed-length bit string format) generated by the encoding format generating unit 128 according to this embodiment. As illustrated in FIG. 16, after a zero bit encoding process is performed on DCT coefficients related to a luminance (Y), a U component, and a V component that have been quantized, a fixed-length bit string (fixed-length data) formed with 144 bits is generated with the use of the DCT coefficients. As illustrated in FIG. 16, “64 bits” are assigned to the bit string corresponding to the luminance (Y), “32 bits” are assigned to the bit string corresponding to the DCT coefficient of the U component, and “32 bits” are assigned to the bit string corresponding to the DCT coefficient of the V component. In other words, a fixed-length bit string according to this embodiment is formed with 144 bits.

Embodiment of a Decoding Device

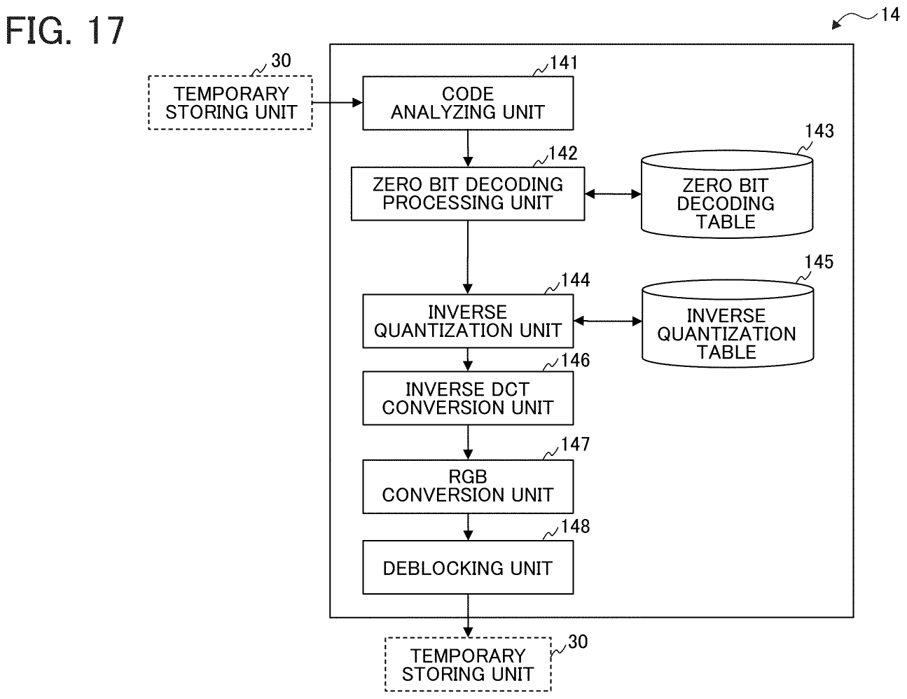

Next, the functional blocks of the fixed-length decoding unit 14 corresponding to an embodiment of a decoding device according to the present invention are described in detail, with reference to FIG. 17. As illustrated in FIG. 17, the fixed-length decoding unit 14 according to this embodiment includes a code analyzing unit 141, a zero bit decoding processing unit 142, a zero bit decoding table 143, an inverse quantization unit 144, an inverse quantization table 145, an inverse DCT conversion unit 146, an RGB conversion unit 147, and a deblocking unit 148.

The code analyzing unit 141 reads a fixed-length bit string having the format illustrated in FIG. 15 and read from the temporary storing unit 30, and transfers a bit string in a zero bit encoding format corresponding to an image block 202 of four pixels×four pixels, to the zero bit decoding processing unit 142. The code analyzing unit 141 corresponds to a code analyzing means.

The zero bit decoding processing unit 142 refers to the zero bit decoding table 143 on the basis of the bit string transferred from the code analyzing unit 141, and identifies a zero bit decoding format. The zero bit decoding processing unit 142 also refers to the zero bit decoding table 143 on the basis of the identified zero bit decoding format, and determines the processing pattern of a zero bit decoding process. On the basis of the determined processing pattern, the zero bit decoding processing unit 142 performs a zero bit decoding process, and then transfers pre-inverse-quantization DCT coefficients (post-quantization DCT coefficients) to the inverse quantization unit 144. The zero bit decoding processing unit 142 will be described later in detail.

The zero bit decoding table 143 stores a zero bit decoding bit number conversion table 710 used by the zero bit decoding processing unit 142. The zero bit decoding table 143 also stores a plurality of zero bit decoding formats. The zero bit decoding table 143 will be described later in detail.

The inverse quantization unit 144 refers to the inverse quantization table 145, and calculates post-inverse-quantization DCT coefficients (pre-quantization DCT coefficients) that are DCT coefficients subjected to an inverse quantization process. The inverse quantization unit 144 transfers the post-inverse-quantization DCT coefficients to the inverse DCT conversion unit 146. The inverse quantization unit 144 corresponds to an inverse quantization means. The inverse quantization table 145 stores shift values for inversely quantizing DCT coefficients. The inverse quantization unit 144 and the inverse quantization table 145 will be described later in detail.

The inverse DCT conversion unit 146 performs an inverse DCT conversion process, on the basis of “the DCT coefficients of the luminance, the U component, and the V component obtained as a result of an inverse quantization process” transferred from the inverse quantization unit 144. As a result, YUV image data is obtained, and this YUV image data is transferred to the RGB conversion unit 147. The inverse DCT conversion unit 146 corresponds to an inverse frequency conversion processing means, and forms an inverse frequency conversion processing unit.

The RGB conversion unit 147 executes a conversion process to convert the transferred YUV image data into RGB image data. The RGB conversion unit 147 outputs RGB image data formed with pixel blocks of four pixels×four pixels.

The deblocking unit 148 decompresses the pixel blocks transferred from the RGB conversion unit 147 into two-dimensional image data, and thus, generates RGB image data. The deblocking unit 148 transfers the generated RGB image data to the temporary storing unit 30. The deblocking unit 148 corresponds to an image block integrating means, and forms an image block integrating unit.

Details of the Zero Bit Decoding Table

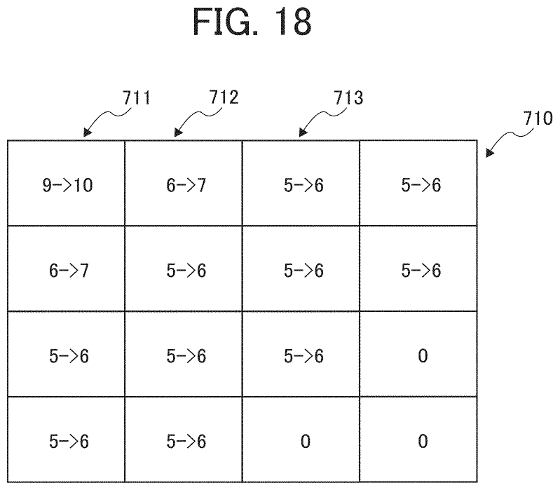

Referring first to FIG. 18, an example of the zero bit decoding bit number conversion table 710 is described. The zero bit decoding bit number conversion table 710 defines the processing pattern of a zero bit decoding process for a bit string that has been subjected to a zero bit encoding process and is a fixed-length bit string. For example, a first decoding processing pattern 711 is executed for a bit string corresponding to “9->10”. The first decoding processing pattern 711 is a zero bit decoding process for converting a 9-bit long fixed-length bit string into a 10-bit long bit string.

Likewise, a second decoding processing pattern 712 is executed for a bit string corresponding to “6->7”. The second decoding processing pattern 712 is a zero bit decoding process for converting a 6-bit long bit length to a 7-bit long bit string. A third decoding processing pattern 713 is executed for a bit string corresponding to “5->6”. The third decoding processing pattern 713 is a zero bit decoding process for converting a 5-bit long bit string to a 6-bit long bit string.

Details of the Zero Bit Decoding Processing Unit

Next, a zero bit decoding process to be performed in the zero bit decoding processing unit 142 is described. As described above, the zero bit decoding format for the block to be processed is determined with reference to the zero bit decoding table 143.

First Decoding Processing Pattern

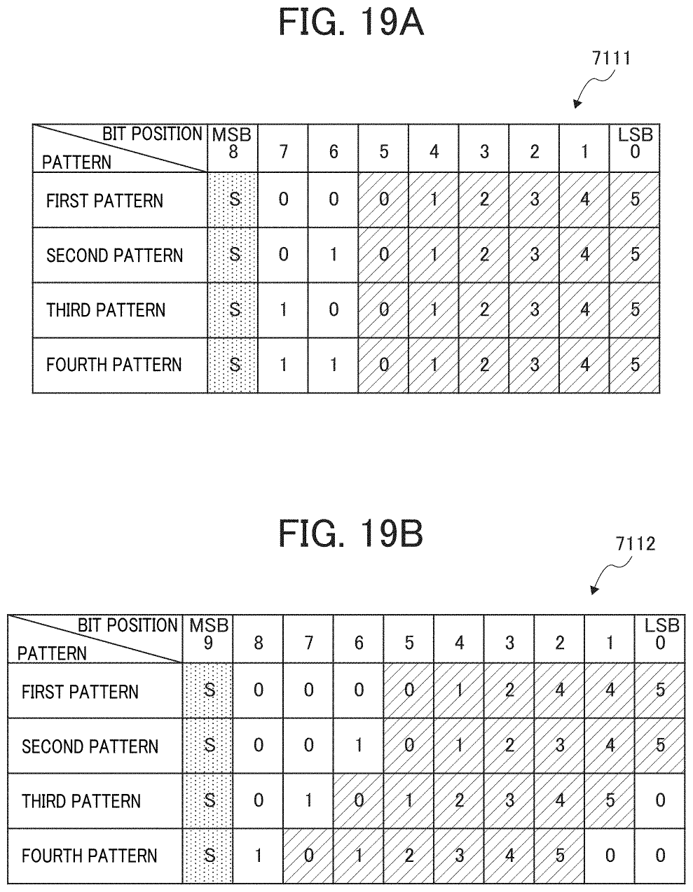

FIGS. 19A and 19B are tables for explaining the first decoding processing pattern 711. FIG. 19A illustrates an example of bit strings before a zero bit decoding process is performed with the first decoding processing pattern 711. FIG. 19B illustrates an example of bit strings after a zero bit decoding process is performed with the first decoding processing pattern 711 (bit strings of pre-inverse-quantization DCT coefficients).

As illustrated in FIG. 19A, a specific processing pattern is determined from a plurality of processing patterns in accordance with a bit string that has been subjected to a zero bit encoding process. In a bit string before a zero bit decoding process (a first pre-decoding bit string 7111), the most significant bit (MSB) is the sign bit (S bit). For the first pre-decoding bit string 7111, a processing pattern is determined from the bit pattern of the highest two bits after the MSB. For example, if the highest two bits after the MSB are “00”, a first pattern is determined to be the processing pattern.

Likewise, if the highest two bits after the MSB are “01”, a second pattern is determined to be the processing pattern. If the highest two bits after the MSB are “10”, a third pattern is determined to be the processing pattern. If the highest two bits after the MSB are “11”, a fourth pattern is determined to be a processing pattern.

On the basis of the processing pattern determined as above, a zero bit decoding process is performed. The processing result will be described with reference to a first post-decoding bit string 7112 in FIG. 19B. In the case of the first pattern, the 7th bit and the 6th bit are “00”, and accordingly, “000” is stored into the highest bits after the MSB in the first post-decoding bit string 7112. Further, the six bits from the 5th bit to the LSB of the first pre-decoding bit string 7111 are assigned to the six bits from the 5th bit to the LSB of the first post-decoding bit string 7112.

In the case of the second pattern, the 7th bit and the 6th bit are “01”, and accordingly, “001” is stored into the highest bits after the MSB in the first post-decoding bit string 7112. Further, the six bits from the 5th bit to the LSB of the first pre-decoding bit string 7111 are assigned to the six bits from the 5th bit to the LSB of the first post-decoding bit string 7112.

In the case of the third pattern, the 7th bit and the 6th bit are “10”, and accordingly, “01” is stored into the highest bits after the MSB in the first post-decoding bit string 7112. Further, the six bits from the 5th bit to the LSB of the first pre-decoding bit string 7111 are assigned to the six bits from the 6th bit to the 1st bit of the first post-decoding bit string 7112. After that, “0” is stored into the LSB.

In the case of the fourth pattern, the 7th bit and the 6th bit are “11”, and accordingly, “1” is stored into the highest bit after the MSB in the first post-decoding bit string 7112. Further, the six bits from the 5th bit to the MSB of the first pre-decoding bit string 7111 are assigned to the six bits from the 7th bit to the 2nd bit of the first post-decoding bit string 7112. After that, “0” is stored into the 1st bit and the LSB.

In a zero bit decoding process, the format of the first pre-decoding bit string 7111 is distinguished by the bit pattern in the “sign bit (S)” in the MSB and the “zero bit header” in the next highest two bits. As a bit operation is performed on the basis of the distinguished processing pattern as described above, a bit string that is nine bits long in the first decoding processing pattern 711 can be extended (decompressed) to 10 bits long.

Second Decoding Processing Pattern

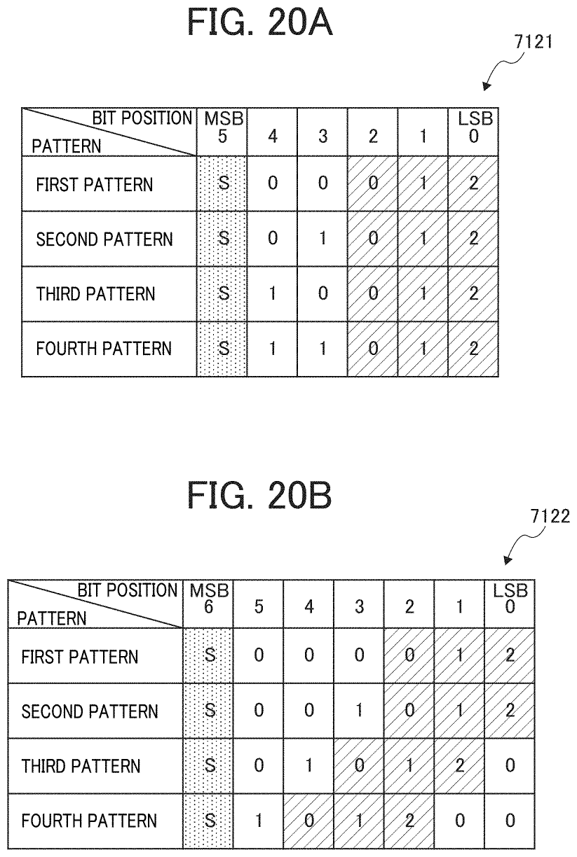

FIGS. 20A and 20B are tables for explaining the second decoding processing pattern 712. FIG. 20A illustrates an example of bit strings before a zero bit decoding process is performed with the second decoding processing pattern 712. FIG. 20B illustrates an example of bit strings after a zero bit decoding process is performed with the second decoding processing pattern 712 (bit strings of pre-inverse-quantization DCT coefficients).

As is apparent from comparisons between FIGS. 20A and 20B and FIGS. 13A and 13B illustrating an example of the second encoding processing pattern 702, the second decoding processing pattern 712 is for performing a bit operation opposite of the second encoding processing pattern 702. In other words, a processing pattern is distinguished and determined from the pattern (bit pattern) of “0” stored in the zero bit header (the 4th bit and the 3rd bit) of a second pre-decoding bit string 7121. On the basis of the determined processing pattern (one of first through fourth patterns), a bit operation opposite of the second encoding processing pattern 702 is performed. The second decoding processing pattern 712 is not specifically described herein.

Third Decoding Processing Pattern

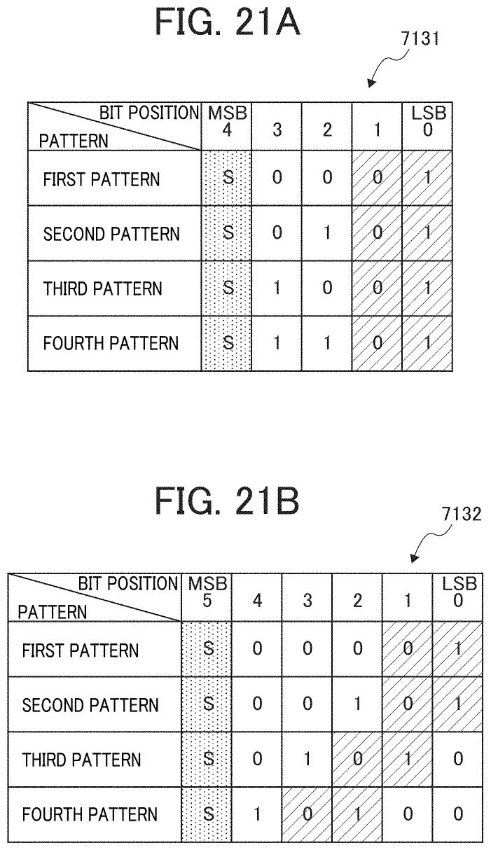

FIGS. 21A and 21B are tables for explaining the third decoding processing pattern 713. FIG. 21A illustrates an example of bit strings before a zero bit decoding process is performed with the third decoding processing pattern 713. FIG. 21B illustrates an example of bit strings after a zero bit decoding process is performed with the third decoding processing pattern 713 (bit strings of pre-inverse-quantization DCT coefficients).

As is apparent from comparisons between FIGS. 21A and 21B and FIGS. 14A and 14B illustrating an example of the third encoding processing pattern 703, the third decoding processing pattern 713 is for performing a bit operation opposite of the third encoding processing pattern 703. In other words, a processing pattern is distinguished and determined from the pattern (bit pattern) of “0” stored in the zero bit header (the 3rd bit and the 2nd bit) of a third pre-decoding bit string 7131. On the basis of the determined processing pattern (one of first through fourth patterns), a bit operation opposite of the third encoding processing pattern 703 is performed. The third decoding processing pattern 713 is not specifically described herein.

Although examples of zero bit decoding formats according to this embodiment and the processing patterns have been described, the zero bit decoding formats and the processing patterns that can be applied to the zero bit decoding processing unit 142 according to this embodiment are limited to those examples. For example, a processing pattern for decompressing eight bits to nine bits may also be used.

Details of the Quantization Table 125

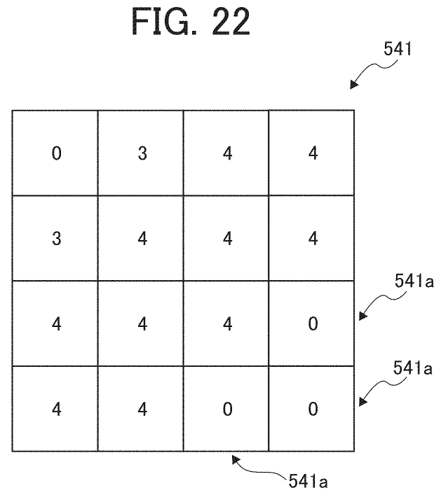

FIG. 22 illustrates an example of an inverse quantization shift value table 541 stored in the quantization table 125. In FIG. 22, examples of the bit shift values corresponding to the respective blocks of the DCT coefficient block 310 are shown. However, “0” in the blocks denoted by reference numeral 541a does not mean that bit shifting is not to be performed, but means that the block is not to be subjected to processing.

Example of Decoded DCT Coefficients

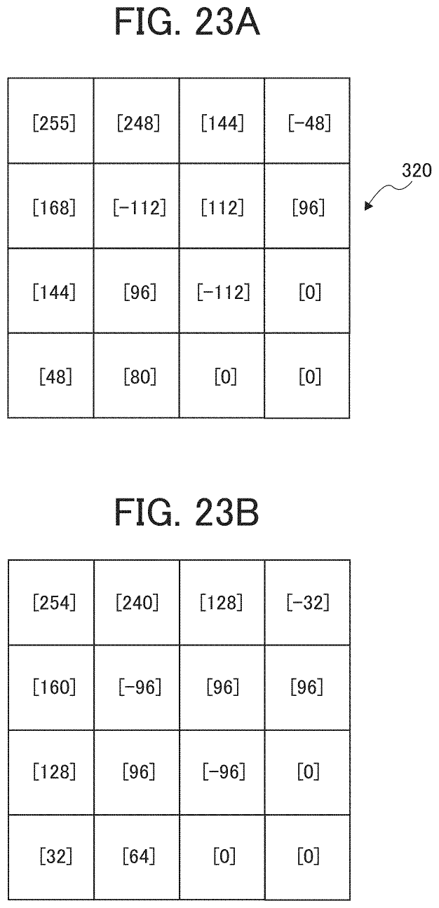

FIG. 23A illustrates an example of a decompressed YUV image block 320 obtained by performing the zero bit encoding process and the zero bit decoding process described above on the YUV image block 300 illustrated in FIG. 8A. FIG. 23B illustrates an example of the result of encoding and decoding into a fixed-length bit string through a conventional DCT process.

As is apparent from a comparison between the original data in FIG. 8A and the decompressed YUV image block 320 that is decompressed data according to this embodiment, the decompressed YUV image block 320 according to this embodiment has a higher accuracy of DCT coefficient decompression than in the conventional example (FIG. 23B). In other words, according to this embodiment, the quality of a decompressed image is higher.

Embodiment of an Encoding Method and a Decoding Method

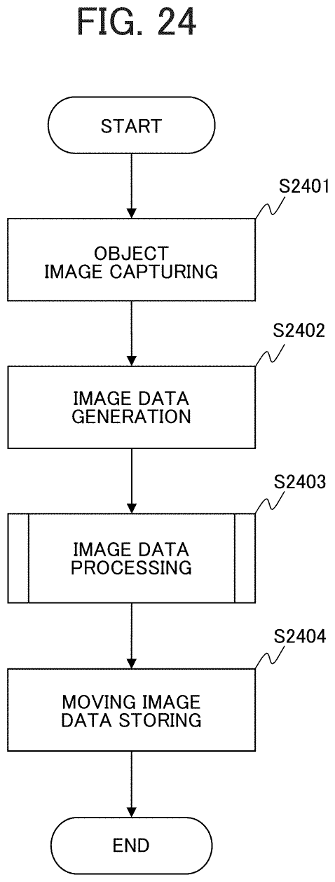

Next, an embodiment of an encoding method and a decoding method according to the present invention is described. FIG. 24 illustrates an example of the flow of an operation in the digital camera 100 described above. The encoding method and the decoding method according to this embodiment are performed in a series of image processing procedures carried out in an image processing apparatus such as the digital camera 100.

First, light reflected by the object is condensed on the imaging surface of the imaging element 103 via the optical system 102, and an image signal output from the imaging element 103 is captured (S2401). Image data is then generated from the image signal by the A/D converter 104, and is input to the processor 101 (S2402). Image data processing is then performed at the processor 101 (S2403). The image data processing will be described later in detail. Moving image data is generated and output through the image data processing at the processor 101, and is stored into the moving image memory 107 (S2404).

Details of the Image Data Processing

In the image data processing in S2403, the encoding method and the decoding method according to this embodiment are applied. Accordingly, an encoding program and a decoding program according to this embodiment are also included in an image processing program for performing the image data processing. In the description below, the encoding method and the decoding method, and execution of the encoding program and the decoding program will also be described, while the image data processing (S2403) will be described in detail.

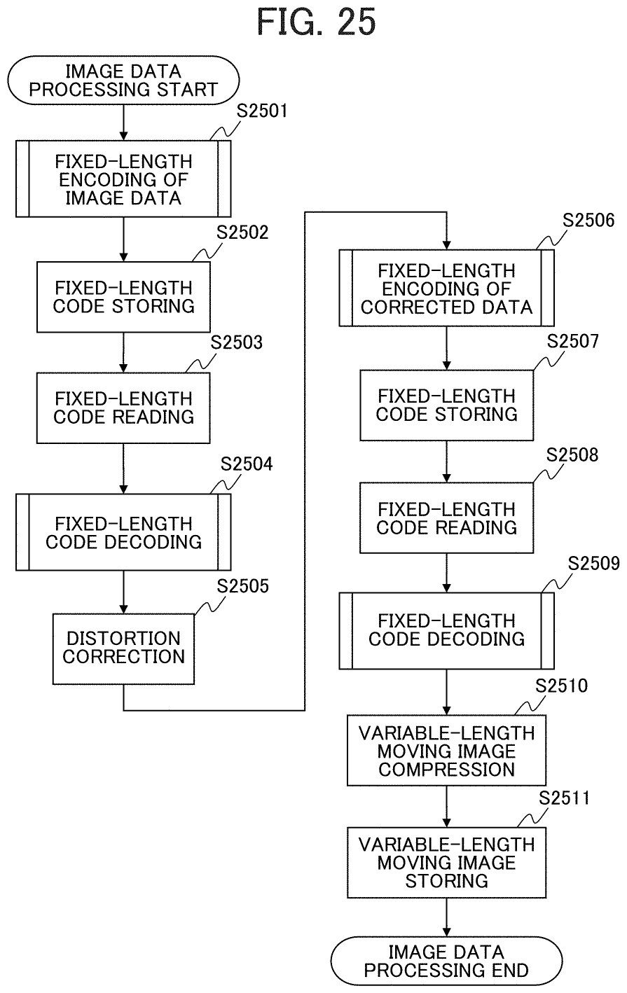

FIG. 25 is a flowchart specifically illustrating the flow of the image data processing in S2403. First, RGB image data is encoded into a fixed-length bit string at the fixed-length encoding unit 12 (S2501). The generated fixed-length bit string is temporarily stored into the temporary storing unit 30 (S2502). The fixed-length decoding unit 14 then reads out the temporarily stored fixed-length bit string, in accordance with an instruction from the distortion correcting unit 13 (S2503).

The fixed-length decoding unit 14 then decodes the fixed-length bit string (S2504). Using the YUV image data obtained by decoding the fixed-length bit string, the distortion correcting unit 13 performs a distortion correction process (S2505).

A fixed-length encoding process is again performed on the YUV image data that has been subjected to the distortion correction process (S2506). The generated fixed-length bit string is temporarily stored into the temporary storing unit 30 (S2507). The fixed-length decoding unit 14 then reads out the temporarily stored fixed-length bit string, in accordance with an instruction from the variable-length moving image compressing unit 15 (S2508).

The fixed-length decoding unit 14 then decodes the fixed-length bit string (S2509). Using the YUV image data obtained by decoding the fixed-length bit string, the variable-length moving image compressing unit 15 generates moving image data (S2510). The generated moving image data is then stored into the image data storage unit 40 (S2511).

Details of the Fixed-Length Encoding Process

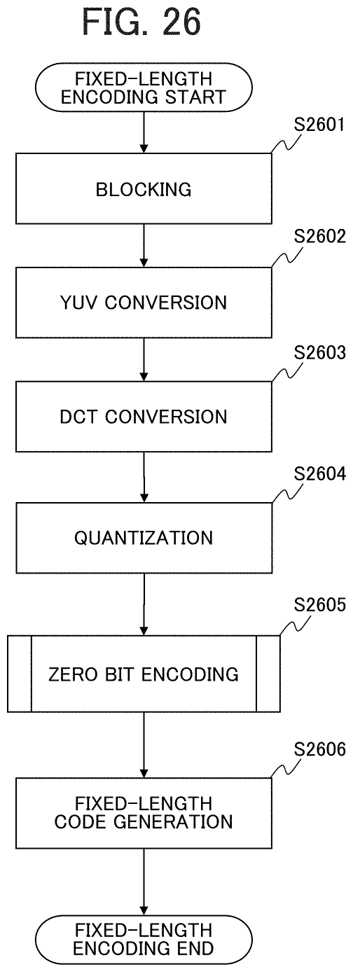

Next, the processing flow in the fixed-length encoding process (S2501, S2506) is described in detail, with reference to the flowchart in FIG. 26.

First, RGB image data generated by the image processor 11 is read from the memory. The blocking unit 121 then generates image blocks of four pixels×four pixels, and outputs the image blocks to the YUV conversion unit 122 (S2601).

The YUV conversion unit 122 then performs a YUV conversion process for converting each of the image blocks from the RGB format into the YUV format, and transfers the generated YUV image block 300 to the DCT conversion unit 123 (S2602).

The DCT conversion unit 123 then performs a frequency conversion process using discrete cosine transform (DCT) on the YUV image block of 4×4 pixels (the YUV image block 300) converted into the YUV format in S2602 (S2603). The DCT conversion unit 123 transfers the DCT coefficient block 310 obtained through the frequency conversion process, to the quantization unit 124.

By referring to the quantization table 125, the quantization unit 124 performs a quantization process on the DCT coefficient corresponding to each block in the transferred DCT coefficient block 310 (S2604). The quantization unit 124 transfers the post-quantization DCT coefficient block 511 generated through the quantization process, to the zero bit encoding processing unit 126.

The zero bit encoding processing unit 126 then performs a zero bit encoding process on the post-quantization DCT coefficient block 511, and generates a fixed-length bit string based on the generated zero bit encoding format (S2605). This step will be described later in detail.

Lastly, the encoding format generating unit 128 performs a fixed-length bit string generation process (S2606). The details of the fixed-length bit string generation process are based on the operation of the encoding format generating unit 128 described above with reference to FIG. 16.

Details of the Zero Bit Encoding Process

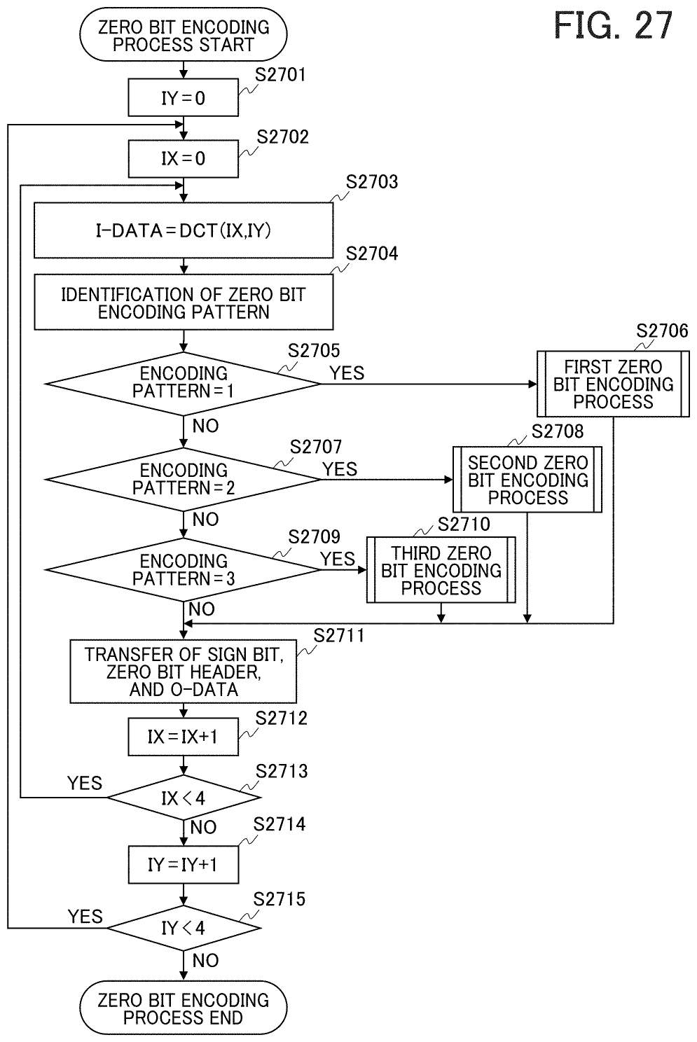

Next, the zero bit encoding process (S2605) is described in detail, with reference to the flowchart in FIG. 27. The zero bit encoding process is performed on each block included in the post-quantization DCT coefficient block 511 (see FIG. 10A) generated by the quantization unit 124.

First, the variables (IX, IY) for identifying the block to be read out are initialized (S2701, S2702). The variables (IX, IY) take values from (0, 0) to (4, 4). This is because the blocks constituting a post-quantization DCT coefficient block 511 correspond to four pixels×four pixels.

From the post-quantization DCT coefficient block 511, the DCT coefficient of the reading target (the block corresponding to (0, 0) in this example) determined by the variables (IX, IV) is input as DCT (IX, IV) to input data (I-DATA) (S2703).

On the basis of the I-DATA, the processing pattern is then identified with reference to the zero bit encoding table 127, and then to the zero bit encoding bit number conversion table 700 (S2704).

If the processing pattern corresponding to the block to be processed is “1” (YES in S2705), a first zero bit encoding process (S2706) is performed (corresponding to the first encoding processing pattern 701).

If the processing pattern corresponding to the block to be processed is “2” (YES in S2707), a second zero bit encoding process (S2708) is performed (corresponding to the second encoding processing pattern 702).

If the processing pattern corresponding to the block to be processed is “3” (YES in S2709), a third zero bit encoding process (S2710) is performed (corresponding to the third encoding processing pattern 703).

The sign bit (S), the zero bit header, and the DCT coefficient actual data (O-DATA) included in each zero bit format related to the zero bit encoding format generated by one of the encoding processes are then transferred to the encoding format generating unit 128 (S2711).

To perform the same processing on all the blocks included in the post-quantization DCT coefficient block 511, “1” is first added to IX (S2712). If IX subjected to the addition is “smaller than 4” (YES in S2713), the process returns to S2703. If IX is not “smaller than 4” (NO in S2713), “1” is added to IY (S2714). If IY subjected to the addition is “smaller than 4” (YES in S2715), the process returns to S2702. If IY is not “smaller than 4” (NO in S2715), the process comes to an end.

Specific Flow of the First Zero Bit Encoding Process

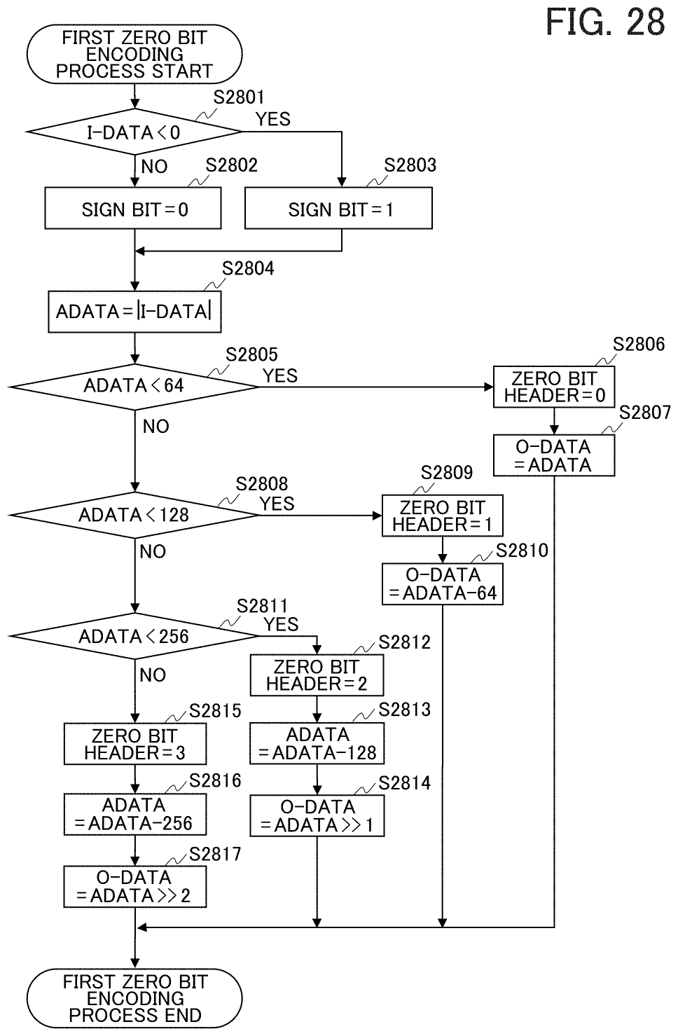

Referring now to the flowchart in FIG. 28, the first zero bit encoding process (S2706) is described in detail. The zero bit encoding process is performed on each block included in the post-quantization DCT coefficient block 511 (see FIG. 10A) generated by the quantization unit 124.

First, a determination process is performed to determine whether the value of the post-quantization DCT coefficient (I-DATA), which is the data to be processed, is “negative” (S2801). If I-DATA is not “negative” (NO in S2801), the sign bit (S) is set to “0” (S2802). If I-DATA is “negative” (YES in S2801), the sign bit (S) is set to “1” (S2803).

The absolute value of I-DATA is set to “ADATA” (S2804), and processing patterns are switched depending on the value of “ADATA”. First, if the value of “ADATA” is “smaller than 64” (YES in S2805), the zero bit header at the 7th bit and the 6th bit is set to “00” (S2806). “ADATA” is then set as the value of “O-DATA” (S2807), and the process is ended.

If the value of “ADATA” is not “smaller than 64” (NO in S2805), but is “smaller than 128” (YES in S2808), the zero bit header at the 7th bit and the 6th bit is set to “01” (S2809). The value obtained by subtracting “64” from “ADATA” is then set as “O-DATA” (S2810), and the process is ended.

If the value of “ADATA” is not “smaller than 128” (NO in S2808), but is “smaller than 256” (YES in S2811), the zero bit header at the 7th bit and the 6th bit is set to “10” (S2812). The value obtained by subtracting “128” from “ADATA” is then set as “O-DATA” (S2813). Further, “O-DATA” is shifted to the right by one bit (S2814), and the process is ended.

If the value of “ADATA” is not “smaller than 256” (NO in S2811), the zero bit header at the 7th bit and the 6th bit is set to “11” (S2815). The value obtained by subtracting “256” from “ADATA” is then set as “O-DATA” (S2816). Further, “O-DATA” is shifted to the right by two bits (S2817), and the process is ended.

Through the above process, a specific DCT coefficient included in the post-quantization DCT coefficient block 511 can be encoded from 10 bits to nine bits.

Specific Flow of the Second Zero Bit Encoding Process

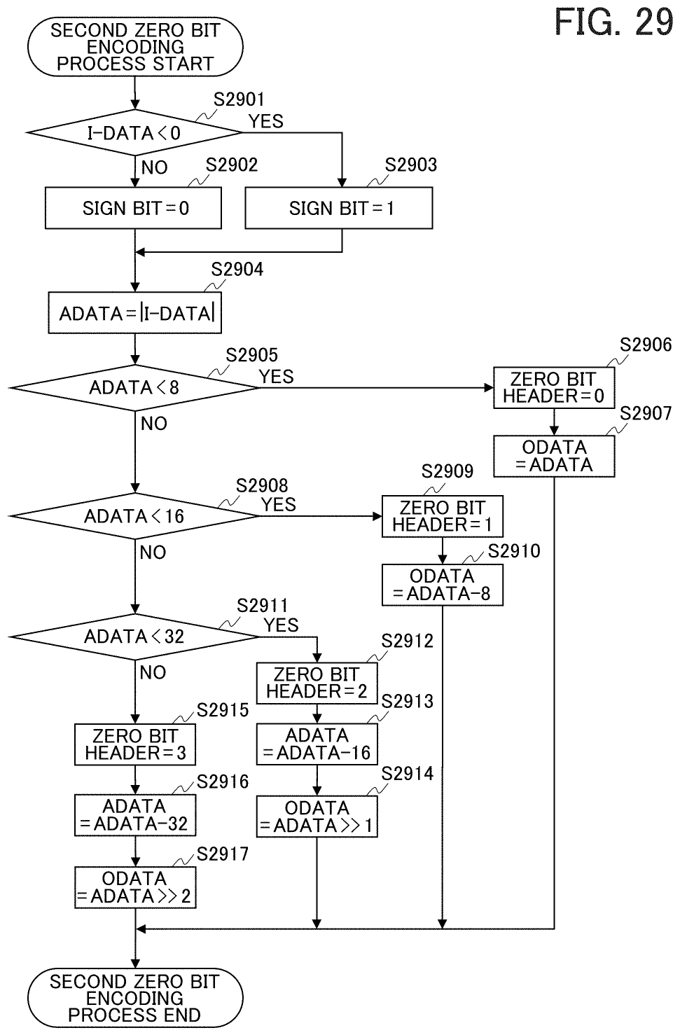

Referring now to the flowchart in FIG. 29, the second zero bit encoding process (S2708) is described in detail. The second zero bit encoding process (S2708) includes the same processes as some of the processes in the first zero bit encoding process (S2706). These common processes are not specifically described herein. The processes from the determination process for determining whether the value of the post-quantization DCT coefficient (I-DATA), which is the data to be processed, is “negative” (S2901), to the process for setting the absolute value of I-DATA as “ADATA” (S2904) immediately before the process for switching processing patterns depending on the value of “ADATA” are the same processes as S2801 through S2804 described above.

If the value of “ADATA” is “smaller than 8” (YES in S2905), the zero bit header at the 7th bit and the 6th bit is set to “00” (S2906). “ADATA” is then set as the value of “0-DATA” (S2907), and the process is ended.

If the value of “ADATA” is not “smaller than 8” (NO in S2905), but is “smaller than 16” (YES in S2908), the zero bit header at the 7th bit and the 6th bit is set to “01” (S2909). The value obtained by subtracting “8” from “ADATA” is then set as “O-DATA” (S2910), and the process is ended.

If the value of “ADATA” is not “smaller than 16” (NO in S2908), but is “smaller than 32” (YES in S2911), the zero bit header at the 7th bit and the 6th bit is set to “10” (S2912). The value obtained by subtracting “16” from “ADATA” is then set as “O-DATA” (S2913). Further, “O-DATA” is shifted to the right by one bit (S2914), and the process is ended.

If the value of “ADATA” is not “smaller than 32” (NO in S2911), the zero bit header at the 7th bit and the 6th bit is set to “11” (S2915). The value obtained by subtracting “32” from “ADATA” is then set as “O-DATA” (S2916). Further, “O-DATA” is shifted to the right by two bits (S2917), and the process is ended.

Through the above process, a specific DCT coefficient included in the post-quantization DCT coefficient block 511 can be encoded from seven bits to six bits.

Specific Flow of the Third Zero Bit Encoding Process

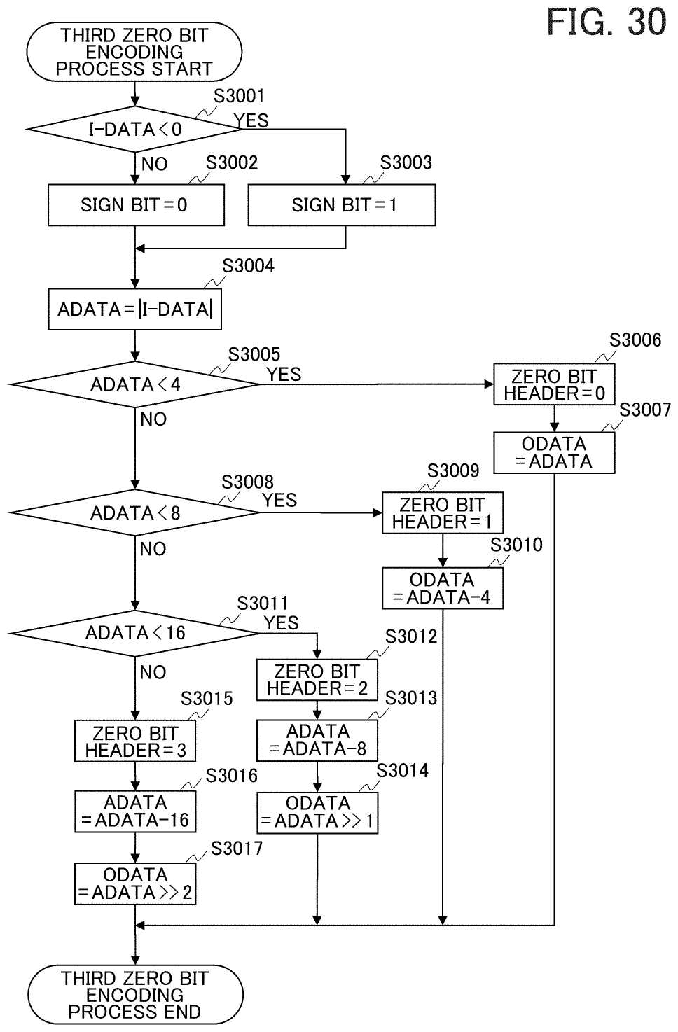

Referring now to the flowchart in FIG. 30, the third zero bit encoding process (S2710) is described in detail. The third zero bit encoding process (S2710) includes the same processes as some of the processes in the first zero bit encoding process (S2706) and the second zero bit encoding process (S2708). These common processes are not specifically described herein. The processes from the determination process for determining whether the value of the post-quantization DCT coefficient (I-DATA), which is the data to be processed, is “negative” (S3001), to the process for setting the absolute value of I-DATA as “ADATA” (S3004) immediately before the process for switching processing patterns depending on the value of “ADATA” are the same processes as S2801 through S2804 and S2901 through S2904 described above.

If the value of “ADATA” is “smaller than 4” (YES in S3005), the zero bit header at the 7th bit and the 6th bit is set to “00” (S3006). “ADATA” is then set as the value of “0-DATA” (S3007), and the process is ended.

If the value of “ADATA” is not “smaller than 4” (NO in S3005), but is “smaller than 8” (YES in S3008), the zero bit header at the 7th bit and the 6th bit is set to “01” (S3009). The value obtained by subtracting “4” from “ADATA” is then set as “O-DATA” (S3010), and the process is ended.

If the value of “ADATA” is not “smaller than 8” (NO in S3008), but is “smaller than 16” (YES in S3011), the zero bit header at the 7th bit and the 6th bit is set to “10” (S3012). The value obtained by subtracting “8” from “ADATA” is then set as “O-DATA” (S3013). Further, “O-DATA” is shifted to the right by one bit (S3014), and the process is ended.

If the value of “ADATA” is not “smaller than 16” (NO in S3011), the zero bit header at the 7th bit and the 6th bit is set to “11” (S3015). The value obtained by subtracting “16” from “ADATA” is then set as “O-DATA” (S3016). Further, “O-DATA” is shifted to the right by two bits (S3017), and the process is ended.

Through the above process, a specific DCT coefficient included in the post-quantization DCT coefficient block 511 can be encoded from six bits to five bits.

In any of the above processing patterns, the value of a DCT coefficient is small in many cases, and the zero bit header is often either “00” or “01”. If the spatial frequency amplitude is large (the value of a DCT coefficient is large), the difference after decompression is hardly recognized even after the amount of information is reduced through quantization.

Details of the Fixed-Length Decoding Process

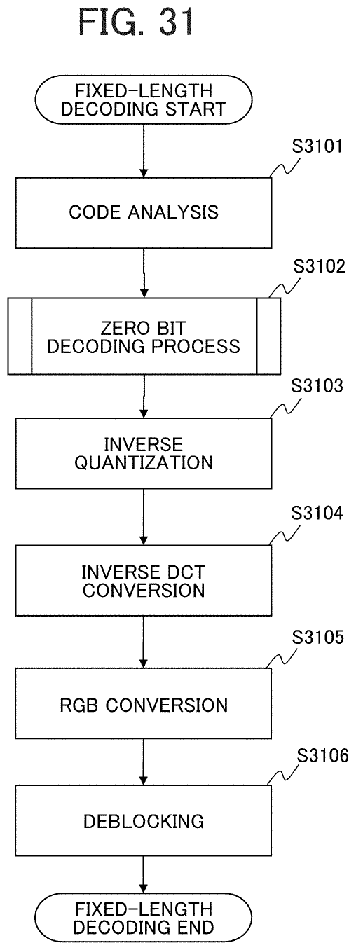

Next, the processing flow in the fixed-length decoding process (S2504, S2509) is described in detail, with reference to the flowchart in FIG. 31.

First, the code analyzing unit 141 reads out the corresponding fixed-length bit string from the temporary storing unit 30, analyzes the bit string to be processed in the fixed-length bit string, and transfers the result to the zero bit decoding processing unit 142 (S3101).

On the basis of the zero bit decoding bit number conversion table 710 stored in the zero bit decoding table 143, the zero bit decoding processing unit 142 identifies the processing pattern from the bit number of the bit string, and performs a zero bit decoding process (S3102). The result of the process is transferred to the inverse quantization unit 144. This step will be described later in detail.

By referring to the inverse quantization table 145, the inverse quantization unit 144 performs an inverse quantization process on the quantized DCT coefficients of the luminance, the U component, and the V component transferred from the zero bit decoding processing unit 142, and transfers the result to the inverse DCT conversion unit 146 (S3103).

The inverse DCT conversion unit 146 then performs inverse DCT conversion on the basis of the transferred DCT coefficients, to generate YUV image data. The generated YUV image data is transferred to the RGB conversion unit 147 (S3104).

The RGB conversion unit 147 then converts the transferred YUV image data into RGB image data (S3105). Lastly, the RGB image data formed with image blocks (image blocks of four pixels×four pixels) is converted into RGB image data decompressed to two-dimensional data, and the generated RGB image data is transferred to the temporary storing unit 30 (S3106).

Details of the Zero Bit Decoding Process

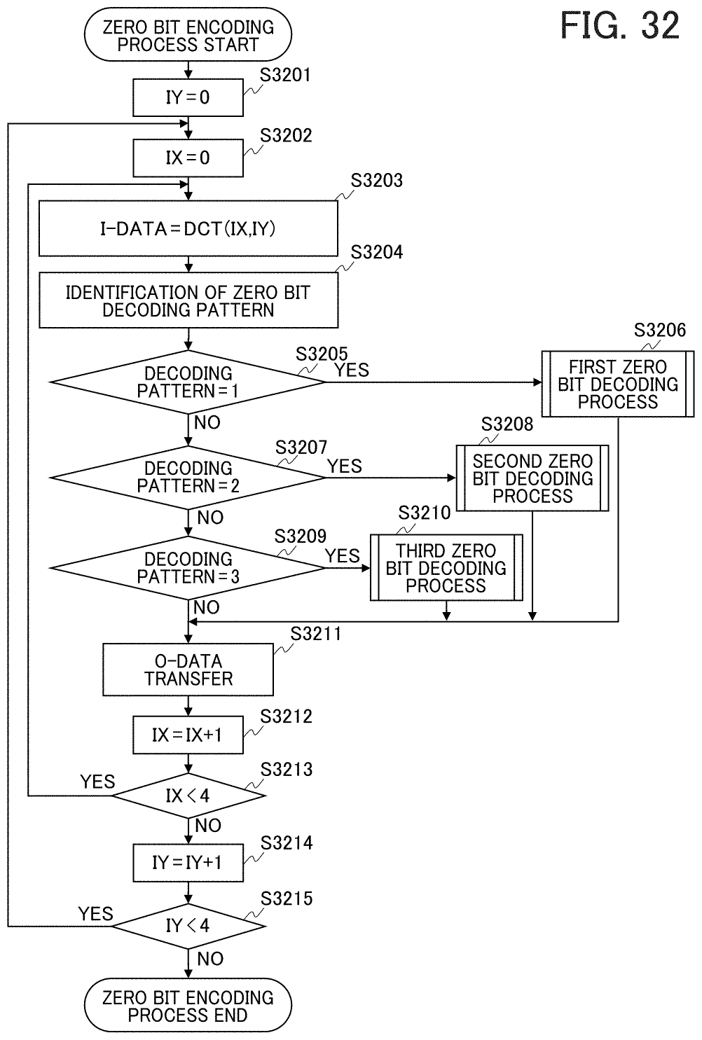

Next, the zero bit decoding process (S3102) is described in detail, with reference to the flowchart in FIG. 32.

First, the variables (IX, IY) for identifying the blocks constituting the post-quantization DCT coefficient block 511 corresponding to a fixed-length bit string received from the code analyzing unit 141 are initialized (S3201, S3202). The variables (IX, IV) take values from (0, 0) to (4, 4). This is because the blocks constituting the post-quantization DCT coefficient block 511 are formed with four pixels×four pixels.

Subsequently, the variables (IX, IV) as the quantized DCT coefficient included in the fixed-length bit string transferred from the code analyzing unit 141 are input to “I-DATA” to be processed in the decoding process (S3203).

On the basis of the I-DATA, the processing pattern is then identified with reference to the zero bit decoding table 143, and then to the zero bit decoding bit number conversion table 710 (S3204).

If the processing pattern corresponding to the block to be processed is “1” (YES in S3205), a first zero bit decoding process (S3206) is performed (corresponding to the first decoding processing pattern 711).

If the processing pattern corresponding to the block to be processed is “2” (YES in S3207), a second zero bit decoding process (S3208) is performed (corresponding to the second decoding processing pattern 712).

If the processing pattern corresponding to the block to be processed is “3” (YES in S3209), a third zero bit decoding process (S3210) is performed (corresponding to the third decoding processing pattern 713).

The post-quantization DCT coefficient generated through one of the decoding processes is transferred as “O-DATA” to the inverse quantization unit 144 (S3211).

After that, to complete the processing of the analyzed fixed-length bit string, “1” is first added to IX (S3213). If IX subjected to the addition is “smaller than 4” (YES in S3213), the process returns to S3203. If IX is not “smaller than 4” (NO in S3213), “1” is added to IY (S3214). If IY subjected to the addition is “smaller than 4” (YES in S3215), the process returns to S3202. If IY is not “smaller than 4” (NO in S3215), the process comes to an end.

Specific Flow of the First Zero Bit Decoding Process

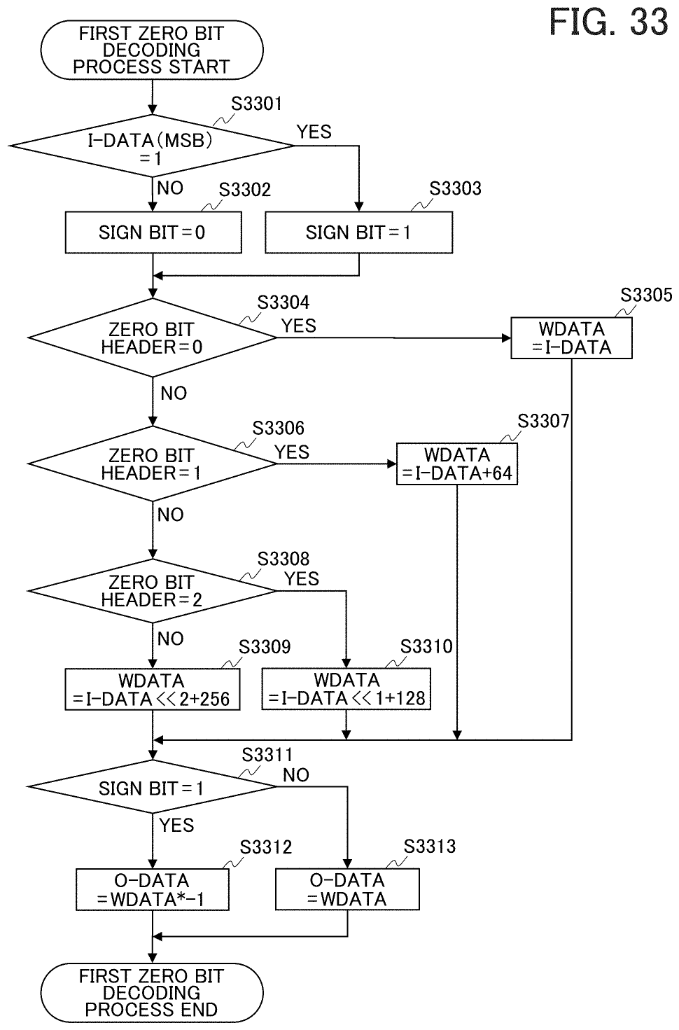

Referring now to the flowchart in FIG. 33, the first zero bit decoding process (S3206) is described in detail. A zero bit decoding process is performed on a fixed-length bit string transferred from the code analyzing unit 141.

First, a determination process is performed to determine whether the most significant bit (MSB) of the bit string (I-DATA), which is the data to be processed, is “1” (S3301). If the MSB is not “1” (NO in S3301), the sign bit (S) is set to “0” (S3302). If the MSB is “1” (YES in S3301), the sign bit (S) is set to “1” (S3303).

Processing patterns are then switched depending on the bit pattern of the zero bit header included in I-DATA. First, if the zero bit header is “00” (YES in S3304), I-DATA is set as write data (WDATA) (S3305). If the zero bit header is not “00” (NO in S3304), but is “01” (YES in S3306), the value obtained by adding “64” to I-DATA is set as “WDATA” (S3307). If the zero bit header is not “01” (NO in S3306), but is “10” (YES in S3308), the value obtained by adding “128” to I-DATA shifted to the left by one bit is set as “WDATA” (S3310). If the zero bit header is not “10” (NO in S3308), the value obtained by adding “256” to I-DATA shifted to the left by two bits is set as “WDATA” (S3309).

A determination process is then performed to determine whether the sign bit of the WDATA bit string is “1” (S3311). If the sign bit is not “1” (NO in S3311), WDATA is set as output data “O-DATA” (S3313), and the process is ended. If the sign bit is “1” (YES in S3311), data obtained by inverting the sign of WDATA is set as “O-DATA” (S3312), and the process is ended.

In a case where the bit length of a fixed-length bit string is nine bits, the fixed-length bit string can be decoded into 10 bits through the above process.

Specific Flow of the Second Zero Bit Decoding Process

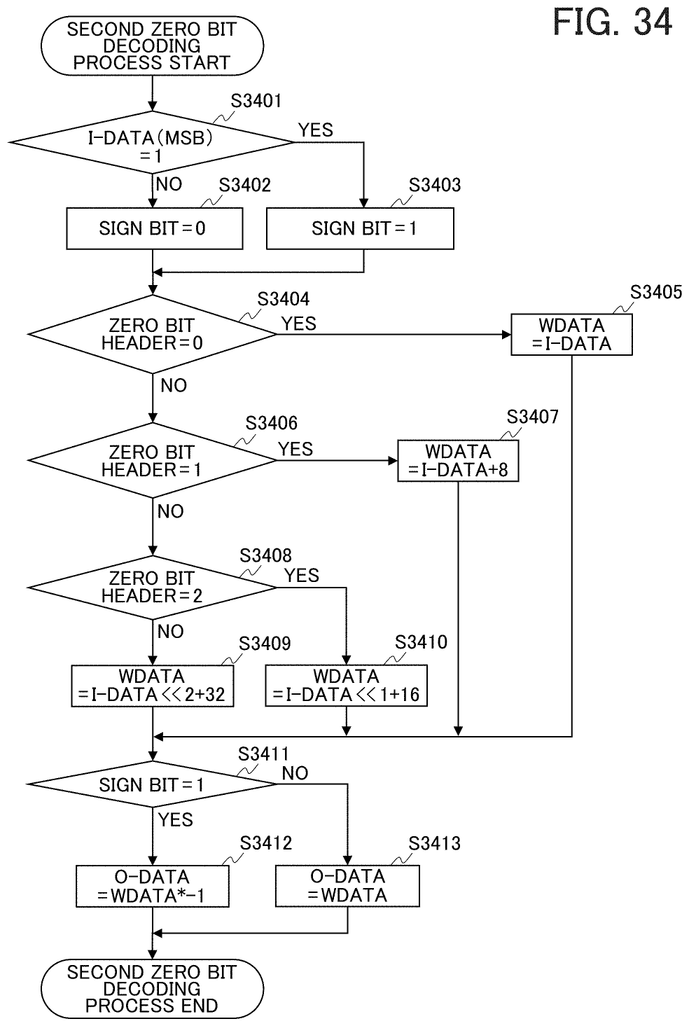

Referring now to the flowchart in FIG. 34, the second zero bit decoding process (S3208) is described in detail. A zero bit decoding process is performed on a fixed-length bit string transferred from the code analyzing unit 141.

First, a determination process is performed to determine whether the most significant bit (MSB) of the bit string (I-DATA), which is the data to be processed, is “1” (S3401). If the MSB is not “1” (NO in S3401), the sign bit (S) is set to “0” (S3402). If the MSB is “1” (YES in S3401), the sign bit (S) is set to “1” (S3403).

Processing patterns are then switched depending on the bit pattern of the zero bit header included in I-DATA. First, if the zero bit header is “00” (YES in S3404), I-DATA is set as write data (WDATA) (S3405). If the zero bit header is not “00” (NO in S3404), but is “01” (YES in S3406), the value obtained by adding “8” to I-DATA is set as “WDATA” (S3407). If the zero bit header is not “01” (NO in S3406), but is “10” (YES in S3408), the value obtained by adding “16” to I-DATA shifted to the left by one bit is set as “WDATA” (S3410). If the zero bit header is not “10” (NO in S3408), the value obtained by adding “32” to I-DATA shifted to the left by two bits is set as “WDATA” (S3409).

A determination process is then performed to determine whether the sign bit of the WDATA bit string is “1” (S3411). If the sign bit is not “1” (NO in S3411), WDATA is set as output data “O-DATA” (S3413), and the process is ended. If the sign bit is “1” (YES in S3411), data obtained by inverting the sign of WDATA is set as “O-DATA” (S3412), and the process is ended.

In a case where the bit length of a fixed-length bit string is six bits, the fixed-length bit string can be decoded into seven bits through the above process.

Specific Flow of the Third Zero Bit Decoding Process

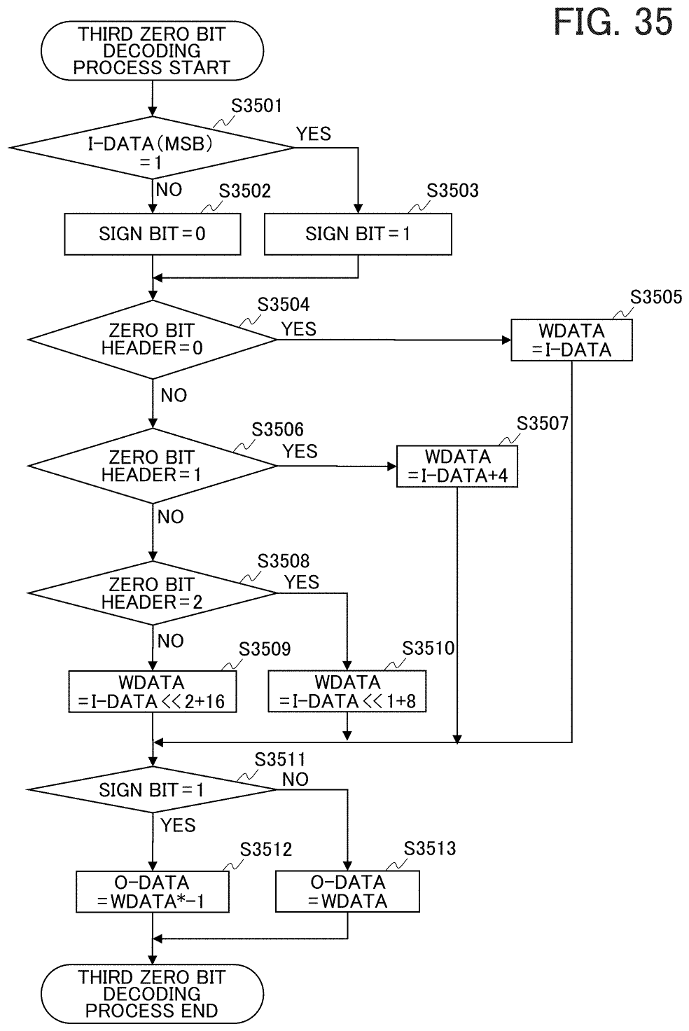

Referring now to the flowchart in FIG. 35, the third zero bit decoding process (S3210) is described in detail. A zero bit decoding process is performed on a fixed-length bit string transferred from the code analyzing unit 141.

First, a determination process is performed to determine whether the most significant bit (MSB) of the bit string (I-DATA), which is the data to be processed, is “1” (S3501). If the MSB is not “1” (NO in S3501), the sign bit (S) is set to “0” (S3502). If the MSB is “1” (YES in S3501), the sign bit (S) is set to “1” (S3503).

Processing patterns are then switched depending on the bit pattern of the zero bit header included in I-DATA. First, if the zero bit header is “00” (YES in S3504), I-DATA is set as write data (WDATA) (S3505). If the zero bit header is not “00” (NO in S3504), but is “01” (YES in S3506), the value obtained by adding “4” to I-DATA is set as “WDATA” (S3507). If the zero bit header is not “01” (NO in S3506), but is “10” (YES in S3508), the value obtained by adding “8” to I-DATA shifted to the left by one bit is set as “WDATA” (S3510). If the zero bit header is not “10” (NO in S3508), the value obtained by adding “16” to I-DATA shifted to the left by two bits is set as “WDATA” (S3509).

A determination process is then performed to determine whether the sign bit of the WDATA bit string is “1” (S3511). If the sign bit is not “1” (NO in S3511), WDATA is set as output data “O-DATA” (S3513), and the process is ended. If the sign bit is “1” (YES in S3511), data obtained by inverting the sign of WDATA is set as “O-DATA” (S3512), and the process is ended.

In a case where the bit length of a fixed-length bit string is five bits, the fixed-length bit string can be decoded into six bits through the above process.

In any of the above processing patterns, the value of a DCT coefficient is small in many cases, and the zero bit header is often either “00” or “01”. If the spatial frequency amplitude is large (the value of a DCT coefficient is large), the difference after decompression is hardly recognized even after the amount of information is reduced through quantization.

As described above, according to the encoding method and the decoding method according to this embodiment, it is possible to reduce the load related to the data access processing by ensuring the same data compression rate as in conventional cases, and achieve a higher image quality after decompression than in conventional cases.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An encoding device configured to encode an image,
the encoding device comprising
processing circuitry configured to:
generate an image block obtained by dividing the image by a predetermined number of pixels;
perform a frequency conversion process on the image block, to generate a frequency conversion coefficient of each pixel in the image block;
generate a quantized coefficient obtained by quantizing the frequency conversion coefficient;
perform a zero bit encoding process on the quantized coefficient, to generate zero bit encoded data; and
generate an image code from the zero bit encoded data.

2. The encoding device according to claim 1,
wherein the processing circuitry determines a zero bit encoding format on basis of a position of a pixel in the image block, and performs a zero bit encoding process on the quantized coefficient corresponding to the pixel on basis of the zero bit encoding format.

3. The encoding device according to claim 1,
wherein the processing circuitry determines a zero bit encoding format on basis of a position of a pixel in the image block, and generates zero bit encoded data having a shorter bit length than a bit length of the quantized coefficient, on basis of the zero bit encoding format.

4. The encoding device according to claim 2,
wherein the zero bit encoding format defines a different bit operation, depending on how zero bits are included in a bit string after a most significant bit.

5. The encoding device according to claim 4,
wherein the zero bit encoding format defines a rule to store a zero bit header in highest two bits after the most significant bit, and a bit string obtained by converting the quantized coefficient into a binary number in remaining lower bits after the zero bit header, depending on how at least zero bits are included in highest three bits in the bit string after the most significant bit.

6. The encoding device according to claim 5,
wherein, when the quantized coefficient is greater than a predetermined value, the zero bit encoding format defines a bit shift operation to eliminate a lower bit of the quantized coefficient stored in the lower bits.

7. The encoding device according to claim 1,
wherein the processing circuitry generates an image block formed with sixteen pixels obtained by dividing the image on a four-pixel basis.

8. A decoding device configured to decode an image code into an image,
the decoding device comprising
processing circuitry configured to:
analyze the image code, to identify a zero bit encoding format of the image code;
generate a quantized coefficient from zero bit encoded data related to the image code, using a zero bit decoding format corresponding to the zero bit encoding format identified;
perform an inverse quantization process on the quantized coefficient, to generate a frequency conversion coefficient;
perform an inverse frequency conversion process on the frequency conversion coefficient, to generate an image block formed with a predetermined number of pixels; and
integrate the image block generated in the inverse frequency conversion process, to generate the image.

9. An encoding method for encoding an image into an image code,
the encoding method comprising:
generating an image block obtained by dividing the image by a predetermined number of pixels;
performing a frequency conversion process on the image block, to generate a frequency conversion coefficient of each pixel in the image block;
generating a quantized coefficient obtained by quantizing the frequency conversion coefficient;
performing a zero bit encoding process on the quantized coefficient, to generate zero bit encoded data; and
generating the image code from the zero bit encoded data.
